(19) United States
(12) Patent Application Publication
(10) Pub. No.: US 2016/0185083 A1
(43) Pub. Date: Jun. 30, 2016

(54) PRESSURE-SENSITIVE-ADHESIVE-LAYER-ATTACHED POLARIZING FILM, AND IMAGE DISPLAY DEVICE

(71) Applicant: NITTO DENKO CORPORATION, Osaka (JP)

(72) Inventors: Atsushi Yasui, Osaka (JP); Shou Takarada, Osaka (JP); Masaki Mizutani, Osaka (JP); Hirofumi Katami, Osaka (JP); Shinya Yamamoto, Osaka (JP)

(73) Assignee: NITTO DENKO CORPORATION, Osaka (JP)

(21) Appl. No.: 14/978,903

(22) Filed: Dec. 22, 2015

(30) Foreign Application Priority Data
Dec. 25, 2014 (JP) 2014-263506

(51) Int. Cl. B32B 7/12; G02F 1/1335; G02B 5/30; B32B 27/08; B32B 27/30

(52) U.S. Cl. CPC B32B 7/12; B32B 27/08; B32B 27/308; G02B 5/3033; G02F 1/133528; B32B 2307/42; B32B 2457/202

(57) ABSTRACT

A pressure-sensitive-adhesive-layer-attached polarizing film, comprising: a polarizing film which is provided nearest to a viewer-side of an image display device among at least one polarizing film used in the device, a pressure-sensitive adhesive layer A arranged at a viewer-side of the polarizing film, and a pressure-sensitive adhesive layer B arranged at a side of the polarizing film that is opposite to the viewer-side of the polarizing film; wherein the pressure-sensitive adhesive layer A is a multiple pressure-sensitive adhesive layer having at least a first pressure-sensitive adhesive layer (a) and a second pressure-sensitive adhesive layer (b) in an order of the recited layers from the outermost surface side of the pressure-sensitive adhesive layer A.

### TECHNICAL FIELD

The present invention relates to a pressure-sensitive-adhesive-layer-attached polarizing film in which a pressure-sensitive adhesive layer is provided on both surfaces of a polarizing film which is nearest to a viewer-side of an image display device among at least one polarizing film used in the device. The invention also relates to an image display device in which at a viewer-side thereof, the pressure-sensitive-adhesive-layer-attached polarizing film is arranged. Examples of the image display device include a liquid crystal display device, an organic EL (electroluminescence) display device, a PDP (plasma display panel), and electronic paper.

The pressure-sensitive-adhesive-layer-attached polarizing film of the present invent ion has a pressure-sensitive adhesive layer over each of the two surfaces of a polarizing film. The pressure-sensitive adhesive layer at a viewer-side of the polarizing film is favorably applicable to, for example, a member to be applied to a viewer-side of an image display device, examples of the member including touch panels and other inputting devices, and cover glasses, plastic covers and other transparent substrates. In the meantime, the pressure-sensitive adhesive layer at the side of the film that is opposite to the viewer-side thereof is applied to a display section of the image display device. The polarizing film of the invention is favorably usable for, e.g., optical type, ultrasonic type, static electricity capacitance type or resistance film type one out of the touch panels. The polarizing film is favorably usable, in particular, for a static electricity capacitance type touch panel. The touch panels are each used in, for example, a portable telephone, a tablet computer, or a portable information terminal although the device in which the touch panel is used is not particularly limited.

### BACKGROUND ART

About any liquid crystal display device or the like, it is indispensable, from the viewpoint of an image-forming manner thereof, that a polarizer is arranged on each of the two main sides of its liquid crystal cell. A polarizing film is generally bonded, as the polarizer, to each of the sides. In order to bond the polarizing film onto a display section side of the liquid crystal cell or the like, a pressure-sensitive adhesive is usually used. In such a case, the following is generally used since the use produces an advantage that no drying step is required for solidifying a polarizing film to be bonded onto such a display section, and other advantages: a pressure-sensitive-adhesive-layer-attached polarizing film in which a pressure-sensitive adhesive layer is beforehand located onto a single side of a polarizing film. As the pressure-sensitive-adhesive-layer-attached polarizing film, various films are suggested (Patent Documents 1 and 2). About these pressure-sensitive-adhesive-layer-attached polarizing films, the pressure-sensitive-adhesive-layer side of the films is applied onto a display section of a liquid crystal cell, or the like.

In the meantime, an inputting device such as a touch panel, a transparent substrate such as a cover glass or plastic cover, or some other member is located at the viewer-side of the polarizing films. The member is also generally bonded through a pressure-sensitive adhesive layer to each of the polarizing films (Patent Document 3).

### PRIOR ART DOCUMENTS

### Patent Documents

Patent Document 1: JP-A-2004-170907

Patent Document 2: JP-A-2006-053531

Patent Document 3: JP-A-2002-348150

### SUMMARY OF THE INVENTION

### Problems to be Solved by the Invention

As described in Patent Documents 1 and 2, about a pressure-sensitive-adhesive-layer-attached polarizing film which is nearest to a viewer-side of an image display device among at least one polarizing film used in the device, the pressure-sensitive adhesive layer of this pressure-sensitive-adhesive-layer-attached polarizing film is bonded onto a display section of the device. In the meantime, when a transparent substrate or some other member is located onto the viewer-side of the pressure-sensitive-adhesive-layer-attached polarizing film (to be located nearest to a viewer-side of an image display device among at least one polarizing film used in the device), a pressure-sensitive sheet for an intermediate film is separately prepared as disclosed in Patent Document 3, and then this sheet is bonded, as a pressure-sensitive adhesive layer, onto the polarizing film of the pressure-sensitive-adhesive-layer-attached polarizing film. Furthermore, the transparent substrate or other member is bonded onto the pressure-sensitive adhesive layer. As described herein, when a transparent substrate, or some other member is further bonded onto a polarizing film nearest to a viewer-side of an image display device among at least one polarizing film used in the device, plural processing-steps are required.

As the pressure-sensitive-adhesive-layer-attached polarizing film, Patent Documents 1 and 2 each disclose a polarizing film having, on each of the two surfaces thereof, a pressure-sensitive adhesive layer (full lamination: double-sided pressure-sensitive-adhesive-layer-attached polarizing film). However, when the double-sided pressure-sensitive-adhesive-layer-attached polarizing film is bonded to an adherend (i.e., a transparent substrate or some other member when the adherend is bonded to a viewer-side of the film; or a display section when the adherend is bonded to the opposite side thereof), the film is required to have durability (reliability) under a high-temperature and a high-humidity environment. However, about the pressure-sensitive-adhesive-layer-attached polarizing film disclosed in each of Patent Documents 1 and 2, it is not conceived that a transparent substrate or some other member is used as the adherend. When a transparent substrate or some other member is bonded onto the pressure-sensitive-adhesive-layer-attached polarizing film disclosed in each of Patent Documents 1 and 2, the pressure-sensitive adhesive layer (at the transparent-substrate- or other-member-bonded side) does not satisfy durability.

In each surface of the transparent substrate or other member, which is, for example, a cover glass, steps are generated by a printed ink present thereon. Thus, when the step-surface-having member is bonded onto another member through a pressure-sensitive adhesive layer, the pressure-sensitive adhesive layer is required to absorb the steps to follow the steps not to generate any gap between the two members. An index of the pressure-sensitive adhesive layer that is related to the steps is a step-absorbing capability (%): the value of [“step height (μm)”/“thickness (μm) of the pressure-sensitive adhesive layer”]×100. In order that the pressure-sensitive adhesive layer can have a satisfied step-following performance, this layer is required to have a step-absorbing capability of about 30%. In recent years, the layer is required to have a high-level step-absorbing capability of 30 to 60%. It is conceivable that in order to absorb the step, the pressure-sensitive adhesive layer is lowered in elastic modulus to be made soft. However, the pressure-sensitive adhesive low in elastic modulus is insufficient in reliability or any other durability.

Furthermore, when made soft, the pressure-sensitive adhesive layer is deteriorated in processability and adhesive residue staining is generated in a large quantity so that the layer is insufficient in handleability. Thus, when a transparent substrate or some other member is bonded to a double-sided pressure-sensitive-adhesive-layer-attached polarizing film through a pressure-sensitive adhesive layer (at the transparent-substrate- or other-member-bonded side) of the polarizing film, the handleability of the polarizing film is insufficient. The double-sided pressure-sensitive-adhesive-layer-attached polarizing films are also required to make the processing-steps simple, and be further improved in workability and yield.

In the meantime, when the pressure-sensitive adhesive layer (at the transparent-substrate- or other-member-bonded side) of the double-sided pressure-sensitive-adhesive-layer-attached polarizing film is made hard, the adhesive layer is lowered in step-absorbing capability by full lamination so that foams are easily generated to deteriorate the reliability.

Thus, an object of the present invention is to provide a pressure-sensitive-adhesive-layer-attached polarizing film which has a reliability to satisfy durability, and can satisfy a step-absorbing capability provided that this film is a film in which a pressure-sensitive adhesive layer is located over each of the two surfaces of a polarizing film which is nearest to a viewer-side of an image display device among at least one polarizing film used in the device.

Another object of the present invention is to provide an image display device having the pressure-sensitive-adhesive-layer-attached polarizing film.

### Means for Solving the Problems

In order to solve the problems, the inventors have made eager investigations to find out a pressure-sensitive-adhesive-layer-attached polarizing film described below. Thus, the present invention has been achieved.

The invention relates to a pressure-sensitive-adhesive-layer-attached polarizing film, comprising: a polarizing film which is provided nearest to a viewer-side of an image display device among at least one polarizing film used in the device, a pressure-sensitive adhesive layer A arranged at a viewer-side of the polarizing film, and a pressure-sensitive adhesive layer B arranged at a side of the polarizing film that is opposite to the viewer-side of the polarizing film;

wherein the pressure-sensitive adhesive layer A is a multiple pressure-sensitive adhesive layer having at least a first pressure-sensitive adhesive layer (a) and a second pressure-sensitive adhesive layer (b) in an order of the recited layers from the outermost surface side of the pressure-sensitive adhesive layer A.

In the pressure-sensitive-adhesive-layer-attached polarizing film of the invention, the pressure-sensitive adhesive layer A and the pressure-sensitive adhesive layer B each is preferably obtained from an acrylic pressure-sensitive adhesive comprising, as a base polymer, a (meth)acryl-based polymer containing, as a monomer unit, an alkyl (meth)acrylate;

the (meth)acryl-based polymer of the pressure-sensitive adhesive layer A comprises, as the monomer unit, 2-ethylhexyl acrylate in a most proportion; and

the (meth)acryl-based polymer of the pressure-sensitive adhesive layer B comprises, as the monomer unit, butyl acrylate in a most proportion.

In the pressure-sensitive-adhesive-layer-attached polarizing film of the invention, wherein the first pressure-sensitive adhesive layer (a) in the pressure-sensitive adhesive layer A and the pressure-sensitive adhesive layer B each is preferably obtained from an acrylic pressure-sensitive adhesive comprising, as a base polymer, a (meth)acryl-based polymer containing an alkyl (meth)acrylate as a monomer unit; and

at least one of the (meth) acryl-based polymer of the first pressure-sensitive adhesive layer (a) of the outermost surface in the pressure-sensitive adhesive layer A, and the (meth) acryl-based polymer of the pressure-sensitive adhesive layer B comprises, as a monomer unit, at least one of (meth)acrylic acid and a cyclic nitrogen-containing monomer.

In the pressure-sensitive-adhesive-layer-attached polarizing film of the invention, the thickness of the first pressure-sensitive adhesive layer (a) of the outermost surface is preferably smallest among all layers of the multiple pressure-sensitive adhesive layer, which is the pressure-sensitive adhesive layer A.

In the pressure-sensitive-adhesive-layer-attached polarizing film of the invention, at least one portion of the edge of the multiple pressure-sensitive adhesive layer, which is the pressure-sensitive adhesive layer A, is preferably positioned inwards from an edge side of the plane of the polarizing film;

the distance X between the edge side of the plane of the polarizing film, and the edge of the first pressure-sensitive adhesive layer (a) of the outermost surface, which is positioned inwards from the edge side of the plane of the polarizing film, is larger than the distance Y between the edge side of the plane of the polarizing film, and the edge of the second pressure-sensitive adhesive layer (b), which is positioned inwards from the edge side of the plane of the polarizing film.

In the pressure-sensitive-adhesive-layer-attached polarizing film of the invention, the pressure-sensitive adhesive layer A is preferably a multiple pressure-sensitive adhesive layer having at least the first pressure-sensitive adhesive layer (a), the second pressure-sensitive adhesive layer (b), and a third pressure-sensitive adhesive layer (c) in an order of the recited layers from the outermost surface side of the pressure-sensitive adhesive layer A.

In the pressure-sensitive-adhesive-layer-attached polarizing film of the invention, a separator SA is preferably provided on the pressure-sensitive adhesive layer A, and a separator SB is preferably provided on the pressure-sensitive adhesive layer B; and

the separator SA is higher in peel strength than the separator SB.

In the pressure-sensitive-adhesive-layer-attached polarizing film of the invention, any moiety of the pressure-sensitive-adhesive-layer-attached polarizing film preferably has an antistatic function.

In the pressure-sensitive-adhesive-layer-attached polarizing film of the invention, a surface of the polarizing film on which the pressure-sensitive adhesive layer A is preferably laminated is subjected to an adhesion-facilitating treatment.

The invention relates to an image display device, comprising at least one pressure-sensitive-adhesive-layer-attached polarizing films;

wherein the pressure-sensitive-adhesive-layer-attached polarizing film which is nearest to a viewer-side of an image display device among at least one polarizing film used in the device, is the pressure-sensitive-adhesive-layer-attached polarizing film of the invention; and

the pressure-sensitive adhesive layer A of the pressure-sensitive-adhesive-layer-attached polarizing film is positioned at the viewer-side, and the pressure-sensitive adhesive layer B of the pressure-sensitive-adhesive-layer-attached polarizing film is positioned at a display section side of the device.

The image display device is favorably applicable to an in-cell or on-cell touch-sensor built-in liquid crystal display device.

In image display devices, at a position at a viewer-side of the devices and outside the polarizing film which is nearest to a viewer-side of an image display device among at least one polarizing film used in the device, a cover glass or any other transparent substrate, or some other member may be arranged. Conventionally, at the viewer-side, a pressure-sensitive adhesive layer and the substrate or other member are successively laminated onto the polarizing film. However, the pressure-sensitive-adhesive-layer-attached polarizing film of the present invention is a double-sided pressure-sensitive-adhesive-layer-attached polarizing film in which a pressure-sensitive adhesive layer to be bonded onto a transparent substrate or some other member is located on one surface of a polarizing film while another pressure-sensitive adhesive layer to be bonded to a display section of an image display device is located on the film surface opposite thereto. The polarizing film has, at a viewer-side thereof also, one of the pressure-sensitive adhesive layers; thus, production-steps of the image display device can be simplified. Moreover, according to the polarizing film, in which the pressure-sensitive adhesive layer is beforehand laid on each of the two surface, by the working of this film into pieces each having a predetermined size, the resultants or the image display device can be improved in productivity and quality.

Furthermore, in the pressure-sensitive-adhesive-layer-attached polarizing film of the present invention, the transparent-substrate- or other-member-bonded side pressure-sensitive adhesive layer is a multiple pressure-sensitive adhesive layer including at least two pressure-sensitive adhesive layers. Even when the transparent substrate or other member is a member having, in its surface, steps, this multiple pressure-sensitive adhesive layer follows the steps to be bondable to the substrate or other member without generating any gap.

Additionally, the multiple pressure-sensitive adhesive layer satisfies step-absorbing capability due to a lamination structure thereof. Thus, even when the pressure-sensitive adhesive layer is made large in storage modulus to be hardened, the layer can satisfy step-absorbing capability. For this reason, according to the multiple pressure-sensitive adhesive layer, the storage modulus can be controlled, whereby the polarizing film of the present invention can satisfy durability while this adhesive layer can satisfy step-absorbing capability.

### BRIEF DESCRIPTION OF THE DRAWINGS

FIG. 1A is a sectional view that schematically illustrates an embodiment of the pressure-sensitive-adhesive-layer-attached polarizing film of the present invention;

FIG. 1B is a sectional view that schematically illustrates an embodiment of the pressure-sensitive-adhesive-layer-attached polarizing film of the invention;

FIG. 2 is an enlarged sectional view that schematically illustrates a form of a pressure-sensitive adhesive layer A in the pressure-sensitive-adhesive-layer-attached polarizing film of the invention;

FIG. 3 is a view that schematically illustrates a state that an image display device, and a transparent substrate or some other members are bonded to each other through the pressure-sensitive-adhesive-layer-attached polarizing film of the invention;

FIG. 4A is a sectional view that schematically illustrates an embodiment of an image display device of the invention;

FIG. 4B is a sectional view that schematically illustrates an embodiment of the image display device; and

FIG. 4C is a sectional view that schematically illustrates an embodiment of the image display device.

### DETAILED DESCRIPTION OF THE PREFERRED EMBODIMENTS

Hereinafter, with reference to the drawings, embodiments of the pressure-sensitive-adhesive-layer-attached polarizing film and the image display device of the present invention will be detailed in detail. However, the invention is not limited to the embodiments in the drawings.

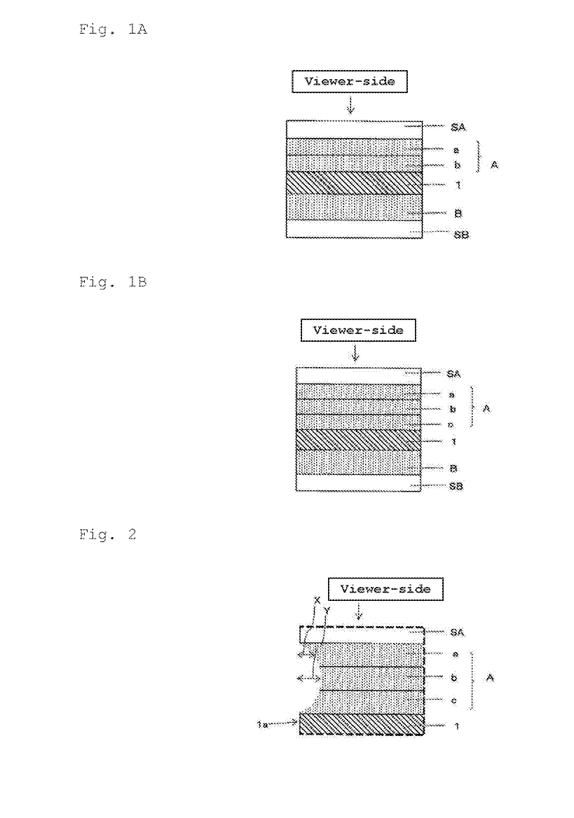

As illustrated in each of FIGS. 1A and 1B, a pressure-sensitive-adhesive-layer-attached polarizing film of an embodiment of the present invention has a polarizing film 1, and a pressure-sensitive adhesive layer A and a pressure-sensitive adhesive layer B on the two surfaces of the polarizing film 1, respectively. The pressure-sensitive adhesive layer A is a multiple pressure-sensitive adhesive layer having a first pressure-sensitive adhesive layer (a) and a second pressure-sensitive adhesive layer (b) in an order of the described layers from the outermost surface side (viewer-side) thereof. In FIG. 1A, the pressure-sensitive adhesive layer A is exemplified by a multiple layer composed of two layers of a first pressure-sensitive adhesive layer (a) and a second pressure-sensitive adhesive layer (b). In FIG. 1B, the pressure-sensitive adhesive layer A is exemplified by a multiple layer composed of three layers of a first pressure-sensitive adhesive layer (a), a second pressure-sensitive adhesive layer (b), and a third pressure-sensitive adhesive layer (c). The number of layers in the multiple pressure-sensitive adhesive layer, which is the pressure-sensitive adhesive layer A, is not particularly limited. Usually, the number is about 5 or less. The number of the layers of the multiple pressure-sensitive adhesive layer is preferably from 2 to 4, more preferably from 2 to 3. In the multiple pressure-sensitive adhesive layer, the individual layers are laid to be caused to adhere directly and closely to each other.

Any adjacent two out of the layers of the multiple pressure-sensitive adhesive layer are pressure-sensitive adhesive layers different from each other in composition. However, any two not adjacent to each other, out of the layers, may be pressure-sensitive adhesive layers having the same composition. In FIG. 1A, the first and second pressure-sensitive adhesive layers (a) and (b) have different compositions. In FIG. 1B, the first and second pressure-sensitive adhesive layers (a) and (b) have different compositions, and the second and third pressure-sensitive adhesive layers (b) and (c) have different compositions. The first, second and third pressure-sensitive adhesive layers (a), (b) and (c) may be different from each other in composition; however, the first and third pressure-sensitive adhesive layers (a) and (c) may have the same composition.

As illustrated in each of FIGS. 1A and 1B, in the pressure-sensitive-adhesive-layer-attached polarizing film of the present invention, a separator SA may be provided on the pressure-sensitive adhesive layers A and a separator SB may be provided on the pressure-sensitive adhesive layers B.

At least one portion of the edge of the multiple pressure-sensitive adhesive layer, which is the pressure-sensitive adhesive layer A, is preferably positioned inwards (or has a structure dented) from an edge side of the plane of the polarizing film 1. The adaptation of this structure about the pressure-sensitive adhesive layer A makes it possible to maintain the external appearance of the edge of the pressure-sensitive adhesive layer A satisfactorily, so that the pressure-sensitive-adhesive-layer-attached polarizing film is good in handleability. For example, when such pressure-sensitive-adhesive-layer-attached polarizing films are transported, blocking therebetween can be prevented. As illustrated in FIG. 3, when the pressure-sensitive adhesive layer A of the pressure-sensitive-adhesive-layer-attached polarizing film is applied to a member C, the generation of adhesive residue staining can be restrained. Moreover, when a display area of a display section D of an image display device has a design very close to the size of a package therefor, the image display device can be fabricated without causing the pressure-sensitive adhesive layer A to adhere onto the package, around the display area, by processing the pressure-sensitive adhesive layer A to be positioned inside the edge of the polarizing film 1.

The dented structure of the pressure-sensitive adhesive layer A may be formed along all edge sides of the polarizing film (pressure-sensitive adhesive layer A), or may be formed along a portion of all the edge sides. When the polarizing film is, for example, rectangular, the pressure-sensitive adhesive layer A can adopt one or more dented structures positioned inside one or more of the four edge sides of the film.

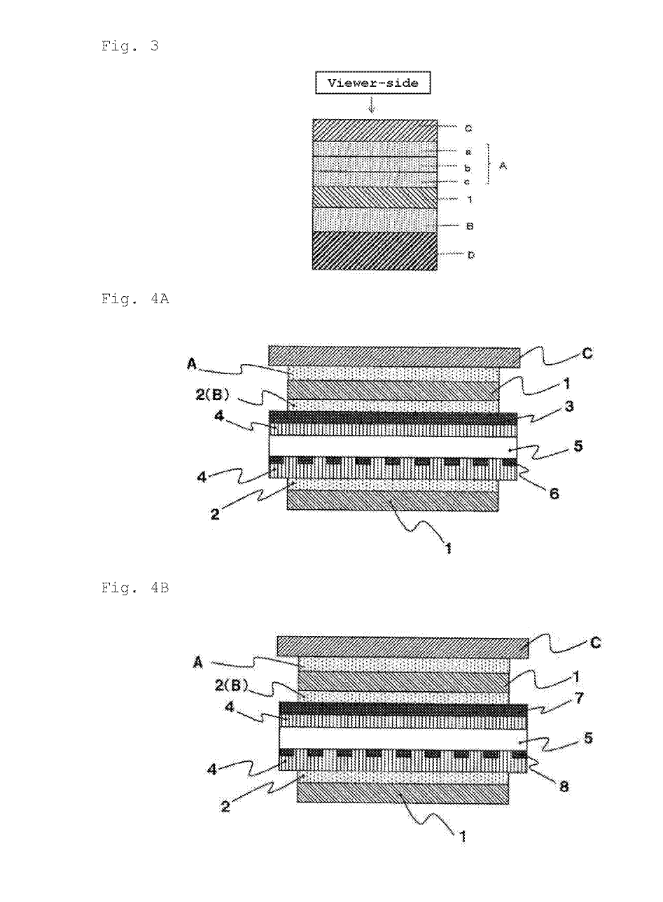

FIG. 2 is an enlarged sectional view that schematically illustrates a form of the pressure-sensitive adhesive layer A in the pressure-sensitive-adhesive-layer-attached polarizing film shown in FIG. 1B. As illustrated in FIG. 2, it is preferred, from the viewpoint of the handleability and the blocking-preventing performance of this film, that the dented structure of the pressure-sensitive adhesive layer A is worked to make the former of the following distances longer than the latter: the distance (dented quantity) X between an edge side 1a of the plane of the polarizing film 1 and the edge of the first pressure-sensitive adhesive layer (a) of the outermost surface, the edge being inside the edge side 1a of the plane of the polarizing film 1; and the distance (dented quantity) Y between the edge side of the plane of the polarizing film 1 and the edge of the second pressure-sensitive adhesive layer (b), the edge being inside the edge side of the plane of the polarizing film 1.

The distance X related to the first pressure-sensitive adhesive layer (a) and the distance Y related to the second pressure-sensitive adhesive layer (b) preferably satisfy a relationship of “distance X<distance Y”. In the case of supposing, for example, a polarizing film having a diagonal line length of 10 to 500 mm, the distance X is preferably from 0 to 1 mm, more preferably from 0.005 to 0.5 mm. The distance Y is preferably from 0.01 to 1.5 mm, more preferably from 0.02 to 1 mm. The difference between the distances X and Y is preferably from 0.005 to 0.5 mm, more preferably from 0.01 to 0.3 mm. The measurement of the distances X and Y can be made through a microscope. When the respective edges of the first, second and third pressure-sensitive adhesive layer (a), (b) and (c) are bent as illustrated in FIG. 2, the distance between the center of the bent of these layers and the corresponding edge side of the film is measured.

When the pressure-sensitive adhesive layer A is composed of three or more layers, the dented structure of the pressure-sensitive adhesive layer A is preferably in a state that the dented quality (the afore-mentioned edge-side/edge distance) of the first pressure-sensitive adhesive layer A, and that of the pressure-sensitive adhesive layer contacting the polarizing film 1 are each smaller than the dented quality (the edge-side/edge distance) of the pressure-sensitive adhesive layer between the first pressure-sensitive adhesive layer (a) and the pressure-sensitive adhesive layer contacting the polarizing film 1. The first pressure-sensitive adhesive layer (a) and the pressure-sensitive adhesive layer contacting the polarizing film 1 preferably has the afore-mentioned preferred range of the edge-side/edge distance X (dented quality). The pressure-sensitive adhesive layer between the first pressure-sensitive adhesive layer (a) and the pressure-sensitive adhesive layer contacting the polarizing film 1 preferably has the afore-mentioned preferred range of the edge-side/edge distance Y (dented quality).

FIG. 2 illustrates a case where the pressure-sensitive adhesive layer A has respective dent structures of three layers of the first, second and third pressure-sensitive adhesive layers (a), (b) and (c). FIG. 2 also illustrates a case where in the same manner as the first pressure-sensitive adhesive layer (a), the edge of the third pressure-sensitive adhesive layer (c) is is positioned inwards from the edge side of the plane of the polarizing film 1.

The dented structure(s) of the pressure-sensitive adhesive layer A can be formed by, for example, a method of making a design to form the pressure-sensitive adhesive layer inwards by a predetermined distance from the edge of a punched-out optical film when a pressure-sensitive adhesive for the layer is applied or transferred onto the film. The dented structure(s) may be formed by a method of a (half-cut) method of applying or transferring the pressure-sensitive adhesive layer onto an optical film, and then removing the adhesive layer only on a region of the layer where the dent(s) is/are to be formed. The dented structure(s) may be formed by a method in which when pressure-sensitive adhesive layers of the pressure-sensitive adhesive layer A, which is a multiple pressure-sensitive adhesive layer, are laminated, these layers are appropriately and successively formed onto a separator smaller in area than the polarizing film 1 onto which the pressure-sensitive adhesive layer A is to be formed, and finally bonding the layer-laminated separator SA onto the polarizing film 1. Moreover, the pressure-sensitive adhesive layer may be made into a state of being protruded from the edge of the polarizing film 1 by pressurization, and subsequently cutting the protruded portion.

As illustrated in FIG. 3, the pressure-sensitive-adhesive-layer-attached polarizing film of the present invention is applied to an image display device. The polarizing film of the present pressure-sensitive-adhesive-layer-attached polarizing film is used as a polarizing film which is nearest to a viewer-side of an image display device among at least one polarizing film used in the device. The pressure-sensitive adhesive layer A of the present pressure-sensitive-adhesive-layer-attached polarizing film is arranged at the viewer-side of the image display device, and is bonded to a member C, such as a transparent substrate. The pressure-sensitive adhesive layer B is arranged at the side of the polarizing film 1 that is opposite to the pressure-sensitive adhesive layer A side, and is bonded to a display section D of the device.

The member C may be a member used at the viewer-side of the image display device, such as a touch panel or any other inputting device, or a cover glass, a plastic cover or any other transparent substrate.

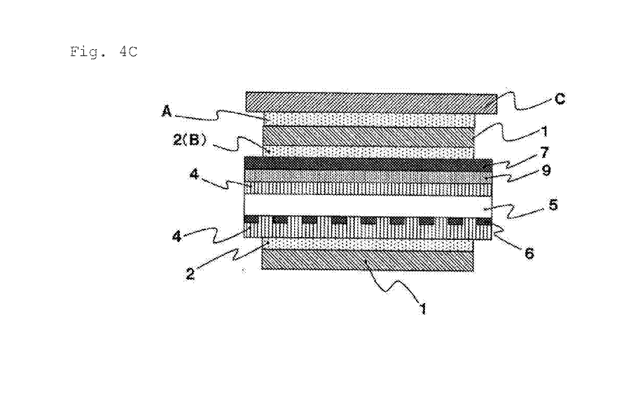

The display section D is a section combined with the polarizing film 1 and the same polarizing film (s) to form a section of the image display device, and may be, for example, a liquid crystal display device, an organic EL (electroluminescence) display device, a PDP (plasma display panel), or electric paper. The display section D is used together with the polarizing film 1. A liquid crystal display device having a liquid crystal layer is favorably usable. FIGS. 4A to 4C each illustrate, as a schematic sectional view, a typical embodiment of an image display device (liquid crystal display device) to which the pressure-sensitive-adhesive-layer-attached polarizing film of the present invention is applied. In the image display device (liquid crystal display device) in each of FIGS. 4A to 4C, the polarizing film 1 at its upper region is nearest to a viewer-side of an image display device among at least one polarizing film used in the device.

The image display device (liquid crystal display device) illustrated in FIG. 4A has a structure of “cover glass C/pressure-sensitive adhesive layer A/polarizing film 1 (at the viewer-side)/pressure-sensitive adhesive layer 2 (B)/antistatic layer 3/glass substrate 4/liquid crystal layer 5/driving electrode 6/glass substrate 4/pressure-sensitive adhesive layer 2/polarizing film 1”. The antistatic layer 3 and the driving electrode 6 may be made of a transparent conductive layer. The antistatic layer 3 is optionally formed.

The image display device (liquid crystal display device) illustrated in FIG. 4B is a device in which a transparent conductive layer is used as an electrode of a touch panel (in-cell type touch panel). The device has a structure of “cover glass C/pressure-sensitive adhesive layer A/polarizing film 1 (at the viewer-side)/pressure-sensitive adhesive layer 2 (B)/antistatic layer 7 functioning also as a sensor layer/glass substrate 4/liquid crystal layer 5/driving electrode 8 functioning also as a sensor layer/glass substrate 4/pressure-sensitive adhesive layer 2/polarizing film 1”. The antistatic layer 7 and the driving electrode 8 may each be made of a transparent conductive layer.

The image display device (liquid crystal display device) illustrated in FIG. 4C is a device in which a transparent conductive layer is used as an electrode of a touch panel (on-cell type touch panel). The device has a structure of “cover glass C/pressure-sensitive adhesive layer A/polarizing film 1/pressure-sensitive adhesive layer 2 (B)/antistatic layer 7 functioning also as a sensor layer/sensor layer 9/glass substrate 4/liquid crystal layer 5/driving electrode 6/glass substrate 4/pressure-sensitive adhesive layer 2/polarizing film 1”. The antistatic layer 7, the sensor layer 9 and the driving electrode 6 may each be made of a transparent conductive layer.

A polarizing film including a polarizer and a transparent protective film provided on one or both sides of the polarizer is generally used. A functional layer such as a hard coat layer may be laid onto the transparent protective film in the polarizing film. Additionally, in the image display device, an optical film is appropriately used which is usable to form a liquid crystal display device, an organic EL display device or some other conventional image display device. The optical film may be used as other optical layers, such as a reflective plate, a transflective plate, a retardation plate (a half wavelength plate and a quarter wavelength plate included), an optical compensation film, a viewing angle compensation film and a brightness enhancement film, which may be used for formation of a liquid crystal display device etc. These films may be singly used as the optical film, or one or more thereof may be used in the state of being laminated onto the polarizing film when practically used.

In each of FIGS. 4A to 4C, the pressure-sensitive adhesive layer 2 is illustrated, which is to be bonded to the liquid crystal cell (glass substrate), or some other member. The pressure-sensitive adhesive layer 2 at the viewer-side (upper side) of the device when viewed from the liquid crystal cell is used as the pressure-sensitive adhesive layer B. For the pressure-sensitive adhesive layer 2, a pressure-sensitive adhesive that may be of various types is appropriately selected to be used, this adhesive containing, as a base polymer, for example, an acryl-based polymer, silicone polymer, polyester, polyurethane, polyamide, polyether, fluoropolymer, or rubber-based polymer. Particularly preferred is an acryl-based pressure-sensitive adhesive or any other pressure-sensitive adhesive having an excellent optical transparency and an appropriate wettability and showing pressure-sensitive adhesive properties of cohesiveness and adhesion to give weather resistance, heat resistance and other properties.

The liquid crystal display device is generally formed, for example, by fabricating appropriately a liquid crystal cell (having a structure of “glass substrate/liquid crystal layer/glass substrate”), polarizing films arranged at both sides thereof, respectively, and optional constituents such as a lighting system, and then incorporating a driving circuit to the fabricated body. The liquid crystal cell may be of any type, such as a TN type, STN type, π type, VA type, or IPS type. Moreover, this liquid crystal display device may be rendered an appropriate display device having a lighting system in which a backlight or reflector is used. When the liquid crystal display device is formed, one or more appropriate members may be arranged in the form of one or more layers at one or more appropriate positions of the device. Examples of the member(s) include a diffusion plate, an antiglare layer, an anti-reflection layer, a protective plate, a prism array, a lens array sheet, a light diffusion plate, and a backlight.

The member C may be a touch panel. The touch panel is a static electricity capacitance type touch panel, in which a transparent substrate, a pressure-sensitive adhesive layer 2, and a transparent conductive film are laminated in this order. Two or more transparent conductive films may be laminated. The transparent substrate may have a sensor layer. The transparent substrate may be singly applied, as a cover glass, a plastic cover or some other, to the image display device (liquid crystal display device). A hard coat film may be laid onto the transparent conductive film at the side of the device that is opposite to the transparent substrate side of the touch panel C.

The transparent substrate may be a glass plate or a transparent acrylic plate (PMMA plate). The transparent substrate is the so-called cover glass, and is usable as a decorative panel. The transparent conductive film is preferably a film in which a transparent conductive film is laid on a glass plate or transparent plastic film (in particular, a PET film). The transparent conductive film may be a thin film made of a metal, a metal oxide, or a mixture of the two, and is, for example, a thin film of ITO (indium tin oxide), ZnO, SnO, or CTO (cadmium tin oxide). The thickness of the transparent conductive film is not particularly limited, and may be from about 10 to 200 nm. A typical example of the transparent conductive film is an ITO film in which an ITO membrane is laid on a PET film. The transparent conductive film may be laid through an undercoat layer onto any member. Plural undercoat layers may be laid. An oligomer-shift preventing layer may be laid between the transparent plastic film substrate and the pressure-sensitive adhesive layer. The hard coat film is preferably a film in which a transparent plastic film such as a PET film is subjected to hard coat treatment.

### <Pressure-Sensitive Adhesive Layers>

Hereinafter, a description will be made about the pressure-sensitive adhesive layers A and B in the present invention. The pressure-sensitive adhesive layers A and B are each “transparent”, and can satisfy the transparency when the layers each have a haze value of 2% or less, the value being measured when the thickness thereof is 25 μm. The haze value is preferably from 0 to 1.5%, more preferably from 0 to 1%.

### <Thickness of Pressure-Sensitive Adhesive Layer>

The pressure-sensitive adhesive layer A is a multiple pressure-sensitive adhesive layer having a first pressure-sensitive adhesive layer (a) and a second pressure-sensitive adhesive layer (b). The total thickness of the pressure-sensitive adhesive layer A is preferably from 5 μm to 1 mm. The total thickness of the pressure-sensitive adhesive layer A can be appropriately set in accordance with a site to which the pressure-sensitive adhesive layer A is applied. The total thickness of the pressure-sensitive adhesive layer A is more preferably from 10 μm to 500 μm, even more preferably from 20 μm to 300 μm.

The thickness of each of pressure-sensitive adhesive layers of the multiple pressure-sensitive adhesive layer, which include the first and second pressure-sensitive adhesive layers (a) and (b), is preferably from 3 to 200 μm, more preferably from 5 to 150 μm, even more preferably from 10 to 100 μm. It is preferred that the first pressure-sensitive adhesive layer (a) of the outermost position, out of the layers of the multiple pressure-sensitive adhesive layer, which is the pressure-sensitive adhesive layer A, has the smallest thickness.

When the pressure-sensitive adhesive layer A has a bilayered structure of the first and second pressure-sensitive adhesive layers (a) and (b) as has been illustrated in FIG. 1A, the thickness of the first pressure-sensitive adhesive layer (a) is preferably from 3 to 200 μm, more preferably from 5 to 100 μm, even more preferably from 10 to 75 μm. The thickness of the second pressure-sensitive adhesive layer (b) is preferably from 10 to 300 μm, more preferably from 20 to 150 μm, even more preferably from 50 to 100 μm. The difference in thickness between the first and second pressure-sensitive adhesive layers (a) and (b) is preferably from 20 to 270 μm, more preferably from 30 to 200 μm from the viewpoint of the step-absorbing capability and workability of the layers.

When the pressure-sensitive adhesive layer A has a trilayered structure of the first, second and third pressure-sensitive adhesive layers (a), (b) and (c) as has been illustrated in FIG. 1B, the respective thicknesses of the first and second pressure-sensitive adhesive layers (a) and (b) are preferably equal in preferred range to those in the case of the bilayered structure. The thickness of the third pressure-sensitive adhesive layer (c) is preferably equal to that of the first pressure-sensitive adhesive layer (a). The first and third pressure-sensitive adhesive layers (a) and (c) may be the same or different in thickness. Equivalently to the difference in thickness between the first and second pressure-sensitive adhesive layers (a) and (b), the difference in thickness between the second and third pressure-sensitive adhesive layers (b) and (c) is preferably from 20 to 270 μm, more preferably from 30 to 200 μm from the viewpoint of the step-absorbing capability and workability of the layers.

In the meantime, the thickness of the pressure-sensitive adhesive layer B is generally from 1 to 500 μm, preferably from 5 to 200 μm, in particular preferably from 10 to 100 μm.

### <Glass Transition Temperature of Pressure-sensitive Adhesive Layer>

The glass transition temperature (Tg-A) of the pressure-sensitive adhesive layer A is preferably from −90 to 25° C., more preferably from −80 to 20° C., even more preferably from −70 to 10° C. from the viewpoint of pressure-sensitive adhesive properties and the workability of the pressure-sensitive adhesive layer.

The glass transition temperature (Tg-B) of the pressure-sensitive adhesive layer B is preferably from −70 to 25° C., more preferably from −60 to 20° C., even more preferably from −50 to 10° C. from the viewpoint of pressure-sensitive adhesive properties and the workability of the pressure-sensitive adhesive layer.

### <Storage Modulus of Pressure-Sensitive Adhesive Layer, and Gel Fraction>

The storage modulus of the pressure-sensitive adhesive layer A at 23° C. is preferably from 0.01 to 1 MPa, more preferably from 0.05 to 0.7 MPa, even more preferably from 0.07 to 0.5 MPa in order that the pressure-sensitive-adhesive-layer-attached polarizing film can satisfy the step-absorbing capability. The gel fraction in the pressure-sensitive adhesive layer A is preferably from 40 to 98% by weight, more preferably from 45 to 85% by weight, even more preferably from 50 to 75% by weight in order that the layer is restrained from being peeled from an adherend.

The pressure-sensitive adhesive layer A may contain an active-energy-ray-cured-pressure-sensitive adhesive layer. When the pressure-sensitive adhesive layer A contains the active-energy-ray-cured-pressure-sensitive adhesive layer, the pressure-sensitive adhesive layer A can be formed by radiating an active energy ray to an active-energy-ray-curable-pressure-sensitive adhesive (first curing: radiation). The pressure-sensitive adhesive layer A can also be formed by heating and drying an active-energy-ray-curable-pressure-sensitive adhesive (first curing: heating). About the pressure-sensitive adhesive layer A formed by applying the first curing (radiation, or heating and drying) onto any one of the active-energy-ray-curable-pressure-sensitive adhesives, the storage modulus is preferably from 0.01 to 0.6 MPa, more preferably from 0.05 to 0.6 MPa, and the gel fraction is preferably from 40 to 80% by weight, more preferably from 45 to 70% by weight from the viewpoint of the step-absorbing capability thereof.

The member C (for example, a transparent substrate such as a cover glass) is bonded to the pressure-sensitive adhesive layer A formed by the application of the first curing (radiation, or heating and drying). After the bonding, an active energy ray may be further radiated to the pressure-sensitive adhesive layer A (second curing). A pressure-sensitive adhesive layer A′ (active-energy-ray-cured-pressure-sensitive adhesive layer) obtained by the application of the second curing can be changed (or improved), by the second curing, in gel fraction and storage modulus from the pressure-sensitive adhesive layer A based on the first curing, so that the layer A′ can be heightened in heating reliability. The storage modulus of the second-curing-applied pressure-sensitive adhesive layer A′ is preferably from 0.04 to 1 MPa, more preferably from 0.08 to 0.8 MPa, and the gel fraction therein is preferably from 60 to 98% by weight, more preferably from 70 to 95% by weight.

The difference between the storage modulus after the second curing and that after the first curing (“the former”−“the latter”) is preferably 0.01 MPa or more, more preferably 0.03 MPa or more. The gel fraction difference (“the gel fraction after the second curing”−“that after the first curing”) is preferably 5% or more by weight, more preferably 10% or more by weight.

In the pressure-sensitive adhesive layer B, no active-energy-ray-cured-pressure-sensitive adhesive layer is usually used. The storage modulus of the pressure-sensitive adhesive layer B at 23° C. is preferably from 0.01 to 1.0 MPa, more preferably from 0.05 to 0.7 MPa, even more preferably from 0.07 to 0.5 MPa in order that the pressure-sensitive adhesive layer B can satisfy workability, storability and durability. The gel fraction in the pressure-sensitive adhesive layer B is preferably from 40 to 95% by weight, more preferably from 45 to 90% by weight, even more preferably from 60 to 85% by weight to restrain the layer from being peeled from an adherend.

### <Peel Strength of Pressure-Sensitive Adhesive Layer>

The pressure-sensitive adhesive layers A and B may have the separators SA and SB, respectively. The peel strength of the separator SA from the pressure-sensitive adhesive layer A is preferably from 0.01 to 5 N/50-mm, more preferably from 0.05 to 2 N/50-mm, even more preferably from 0.1 to 1 N/50-mm. The peel strength of the separator SB from the pressure-sensitive adhesive layer B is preferably from 0.01 to 5 N/50-mm, more preferably from 0.05 to 2 N/50-mm, even more preferably from 0.1 to 1 N/50-mm. When the pressure-sensitive adhesive layer A contains the active energy ray cured adhesive layer, the peel strength of the separator SA denotes a value measured after the first curing of the layer.

It is preferred to make the peel strength of the separator SA higher than that of the separator SB to bond the pressure-sensitive adhesive layer A ahead to a panel. The difference in peel strength between the separators SA and SB is preferably from 0.01 to 2 N/50-mm, more preferably from 0.02 to 1 N/50-mm to prevent a separator-peel failure.

The individual glass transition temperatures, storage moduli, gel fractions, and peel strengths are measured according to a description in the item “Examples”. The pressure-sensitive adhesive layer A is composed of plural pressure-sensitive adhesive layers, and the storage modulus of the layers, and the gel fraction therein are measured, using a dynamic viscoelasticity measuring instrument and a mesh method, respectively, according to the description in the item “Examples”.

### <Material of Pressure-Sensitive Adhesive Layer>

A material for forming each of the pressure-sensitive adhesive layers A and B in the present invention may be a material containing a base polymer that may be of various types. The type of the base polymer is not particularly limited, and examples thereof include rubber-based polymer, (meth)acryl-based polymer, silicone-based polymer, urethane-based polymer, vinyl alkyl ether-based polymer, polyvinyl alcohol-based polymer, polyvinyl pyrrolidone-based polymer, polyacrylamide-based polymer, and cellulose-based polymer.

It is preferred to use, out of these base polymers, any polymer that is excellent in optical transparency, and shows an appropriate wettability and adhesive properties of cohesiveness and adhesion to be excellent in weather resistance, heat resistance and other properties. A polymer showing such characteristics is preferably (meth)acryl-based polymer. Hereinafter, a description will be made about a material for forming the pressure-sensitive adhesive layers A and B, i.e., an acrylic pressure-sensitive adhesive containing, as a base polymer, a (meth)acrylic polymer containing an alkyl (meth)acrylate as a monomer unit.

The (meth)acryl-based polymer is obtained by polymerizing one or more monomer components, the component(s) being/including an alkyl (meth)acrylate having an alkyl group of 4 to 24 carbon atoms at the ester end. As used herein, the term “alkyl (meth)acrylate” refers to alkyl acrylate and/or alkyl methacrylate, and “(meth)” is used in the same meaning in the description.

Examples of the alkyl (meth)acrylate include (meth)acrylates each having a linear or branched alkyl group of 4 to 24 carbon atoms. These alkyl (meth)acrylate may be used alone or in a mixture of two or more

The alkyl (meth)acrylate is, for example, an alkyl (meth)acrylate having a branched alkyl group of 4 to 9 carbon atoms. This alkyl (meth)acrylate is preferred since the resultant polymer easily takes a good balance between adhesive properties. Examples thereof include n-butyl (meth)acrylate, s-butyl (meth)acrylate, t-butyl (meth)acrylate, isobutyl (meth)acrylate, n-pentyl (meth)acrylate, isopentyl (meth)acrylate, isohexyl (meth)acrylate, isoheptyl (meth)acrylate, 2-ethylhexyl (meth)acrylate, isooctyl (meth)acrylate, and isononyl (meth)acrylate. The (meth)acryl-based polymer for the pressure-sensitive adhesive layer A contains, as a monomer unit, 2-ethylhexyl acrylate in a most proportion from the viewpoint of the control of the storage modulus and the step-absorbing capability. The pressure-sensitive adhesive layer A is a multiple pressure-sensitive adhesive layer containing at least a first pressure-sensitive adhesive layer (a) and a second pressure-sensitive adhesive layer (b), and it is preferred about the multiple pressure-sensitive adhesive layer that its (meth)acryl-based polymer contains, as a monomer unit, 2-ethylhexyl acrylate in a most proportion (in the whole of the individual layers). In the meantime, it is preferred that the (meth)acryl-based polymer for the pressure-sensitive adhesive layer B contains, as a monomer unit, butyl acrylate in a most proportion to control the storage modulus of the pressure-sensitive adhesive layer B while the film satisfies workability, storability and durability.

In the present invention, the content of the above-mentioned alkyl (meth)acrylate having an alkyl group of 4 to 24 carbon atoms at the ester end is 40% by weight or more, preferably 50% by weight or more, more preferably 60% by weight or more based on the total weight of the monofunctional monomer component used to form the (meth)acryl-based polymer. The use thereof in the content of 40% or more by weight is preferred since the resultant polymer easily takes a good balance between adhesive properties.

The monomer components for forming the (meth)acryl-based polymer in the present invention may include, as a monofunctional monomer, a copolymerizable monomer other than the alkyl (meth)acrylate. The copolymerizable monomer is usable as a component other than the alkyl (meth)acrylate in the monomer components.

The copolymerizable monomers, for example, may include a cyclic nitrogen-containing monomer. Any monomer having a cyclic nitrogen structure and an unsaturated double bond-containing polymerizable functional group such as a (meth)acryloyl group or a vinyl group may be used without restriction as the cyclic nitrogen-containing monomer. The cyclic nitrogen structure preferably has a nitrogen atom in the cyclic structure. Examples of the cyclic nitrogen-containing monomer include vinyl lactam monomers such as N-vinylpyrrolidone, N-vinyl-ε-caprolactam, and methylvinylpyrrolidone; and nitrogen-containing heterocyclic vinyl monomers such as vinylpyridine, vinylpiperidone, vinylpyrimidine, vinylpiperazine, vinylpyrazine, vinylpyrrole, vinylimidazole, vinyloxazole, and vinylmorpholine. The cyclic nitrogen-containing monomer may also be a (meth)acrylic monomer having a heterocyclic ring such as a morpholine ring, a piperidine ring, a pyrrolidine ring, or a piperazine ring. Examples include N-acryloyl morpholine, N-acryloyl piperidine, N-methacryloyl piperidine, and N-acryloyl pyrrolidine. Among them, vinyl lactam monomers are preferred, in view of dielectric constant and cohesiveness.

In the present invention, the content of the cyclic nitrogen-containing monomer is 40% by weight or less, more preferably from 0.5 to 40% by weight, even more preferably from 0.5 to 30% by weight based on the total weight of the monomer component used to form the (meth)acryl-based polymer. The use of the cyclic nitrogen-containing monomer in the range is preferred for the control of the surface resistance value of the pressure-sensitive-adhesive-layer-attached polarizing film and, in particular, the compatibility of the monomer with an ionic compound when this compound is used in any one of the pressure sensitive adhesive layers, and the durability of the antistatic function of the film.

The monomer component used to form the (meth)acryl-based polymer according to the invention may further include other functional group-containing monomers as a monofunctional monomer. The functional group-containing monomers include a hydroxyl group-containing monomer, a carboxyl group-containing monomer, and a cyclic ether group-containing monomer.

Any monomer having a hydroxyl group and an unsaturated double bond-containing polymerizable functional group such as a (meth)acryloyl group or a vinyl group may be used without restriction as the hydroxyl group-containing monomer. Examples of the hydroxyl group-containing monomer include hydroxyalkyl (meth)acrylate such as 2-hydroxyethyl (meth)acrylate, 2-hydroxypropyl(meth)acrylate, 2-hydroxybutyl(meth)acrylate, 3-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl (meth)acrylate, or 12-hydroxylauryl (meth)acrylate; and hydroxyalkylcycloalkane (meth)acrylate such as (4-hydroxymethylcyclohexyl)methyl (meth)acrylate. Other examples include hydroxyethyl(meth)acrylamide, allyl alcohol, 2-hydroxyethyl vinyl ether, 4-hydroxybutyl vinyl ether, and diethylene glycol monovinyl ether. These may be used alone or in any combination. Among them, hydroxyalkyl (meth)acrylate is preferred.

Any monomer having a carboxyl group and an unsaturated double bond-containing polymerizable functional group such as a (meth)acryloyl group or a vinyl group may be used without restriction as the carboxyl group-containing monomer. Examples of the carboxyl group-containing monomer include (meth)acrylic acid, carboxyethyl (meth)acrylate, carboxypentyl (meth)acrylate, itaconic acid, maleic acid, fumaric acid, crotonic acid, and isocrotonic acid. These may be used alone or in any combination. Itaconic acid or maleic acid can be used in the form of an anhydride. Among these, acrylic acid and methacrylic acid are preferred, and acrylic acid is particularly preferred. In the invention, a carboxyl group-containing monomer may be or may not be used as an optional monomer to produce the (meth)acryl-based polymer. An adhesive containing a (meth)acryl-based polymer obtained from a monomer composition free of any carboxyl group-containing monomer can form a pressure-sensitive adhesive layer with reduced ability to corrode metals, because the ability to corrode metals would be due to any carboxyl group.

Any monomer having a cyclic ether group such as an epoxy group or an oxetane group and an unsaturated double bond-containing polymerizable functional group such as a (meth)acryloyl group or a vinyl group may be used without restriction as the cyclic ether group-containing monomer. Examples of the epoxy group-containing monomer include glycidyl (meth)acrylate, 3,4-epoxycyclohexylmethyl (meth)acrylate, and 4-hydroxybutyl(meth)acrylate glycidyl ether. Examples of the oxetane group-containing monomer include 3-oxetanylmethyl (meth)acrylate, 3-methyl-oxetanylmethyl (meth)acrylate, 3-ethyl-oxetanylmethyl (meth)acrylate, 3-butyl-oxetanylmethyl (meth)acrylate, and 3-hexyl-oxetanylmethyl (meth)acrylate. These monomers may be used alone or in any combination.

In the invention, the content of the hydroxyl group-containing monomer, carboxyl group-containing monomer, and cyclic ether group-containing monomer is preferably 30% by weight or less, more preferably 27% by weight or less, further preferably 25% by weight or less, based on the total weight of the monofunctional monomer component used to form the (meth)acryl-based polymer.

An example of one of the monomer components for forming the (meth)acryl-based polymer in the present invention is an alkyl (meth)acrylate, as the copolymerizable monomer, represented by CH₂═C(R¹) COOR² wherein R¹ represents hydrogen or a methyl group, and R² represents a unsubstituted or substituted alkyl group of 1 to 3 carbon atoms, or a cyclic alkyl group.

The unsubstituted or substituted alkyl group of 1 to 3 carbon atoms represented by R² may be a linear, or branched alkyl group. The substituted alkyl group preferably has an aryl group of 3 to 8 carbon atoms or an aryloxy group of 3 to 8 carbon atoms as a substituent. The aryl group is preferably, but not limited to, a phenyl group.

Examples of the monomer represented by CH₂═C(R¹)COOR² include methyl (meth)acrylate, ethyl (meth)acrylate, phenoxyethyl (meth)acrylate, benzyl (meth)acrylate, cyclohexyl (meth)acrylate, 3,3,5-trimethylcyclohexyl (meth)acrylate, and isobornyl (meth)acrylate. These monomers may be used alone or in any combination.

In the invention, the content of the (meth)acrylate represented by CH₂═C(R¹)COOR² may be 40% by weight or less, preferably 35% by weight or less, more preferably 30% by weight or less, based on the total weight of the monofunctional monomer component used to form the (meth)acryl-based polymer.

Other copolymerizable monomers that may also be used include vinyl acetate, vinyl propionate, styrene, α-methylstyrene; glycol acrylic ester monomers such as polyethylene glycol (meth)acrylate, polypropylene glycol (meth)acrylate, methoxyethylene glycol (meth)acrylate, and methoxypolypropylene glycol (meth)acrylate; and acrylate ester monomers such as tetrahydrofurfuryl (meth)acrylate, fluoro(meth)acrylate, silicone (meth)acrylate, and 2-methoxyethyl acrylate; amide group-containing monomers, amino group-containing monomers, imide group-containing monomers, N-acryloyl morpholine, and vinyl ether monomers. Cyclic structure-containing monomers such as terpene (meth)acrylate and dicyclopentanyl (meth)acrylate may also be used as copolymerizable monomers. Among these, vinyl acetate is preferred in view of improving cohesive strength and adhesive strength.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

The copolymerizable monomer is appropriately selectable when the (meth)acryl-based polymer is prepared in the formation of each of the pressure-sensitive adhesive layers A and B. When the first pressure-sensitive adhesive layer (a) in the pressure-sensitive adhesive layer A, and the pressure-sensitive adhesive layer B are made of an acrylic pressure-sensitive adhesive, at least one of these layers preferably contains, as a monomer unit, at least one of (meth)acrylic acid and a nitrogen-containing monomer in view of improving cohesive strength and adhesive strength.

In the invention, if necessary, the monomer component used to form the (meth)acryl-based polymer may contain a polyfunctional monomer for controlling the cohesive strength of the pressure-sensitive adhesive in addition to the monofunctional monomers listed above.

The polyfunctional monomer is a monomer having at least two polymerizable functional groups with an unsaturated double bond such as (meth)acryloyl group or vinyl group, and examples thereof include ester compounds of a polyhydric alcohol with (meth)acrylic acid such as (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, propoxylated pentaerythritol triacrylate, dipentaerythritol hexa(meth)acrylate, 1,2-ethyleneglycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate; allyl (meth)acrylate, vinyl (meth)acrylate, divinylbenzene, epoxy acrylate, polyester acrylate, urethane acrylate, butanediol di(meth)acrylate, hexanediol di(meth)acrylate, and the like. Among them, trimethylolpropane tri(meth)acrylate, hexanediol di(meth)acrylate, and dipentaerythritol hexa(meth)acrylate can be preferably used. The polyfunctional monomer can be used alone or in combination of two or more.

The use amount of the polyfunctional monomer is varied in accordance with the molecular weight thereof and the number of functional groups thereof, and is preferably 3 parts by weight or less, more preferably 2 parts by weight or less, even more preferably 1 part by weight or less based on 100 parts by weight of the whole of the monofunctional monomer(s). The low limit value thereof is not particularly limited, and is preferably 0 part by weight or more, more preferably 0.001 part by weight or more. When the use amount of the polyfunctional monomer is in the range, the layers can be improved in adhering strength.

The (meth)acryl-based polymer described above can be produced using a method appropriately selected from known production methods, such as solution polymerization, radiation polymerization such as ultraviolet ray polymerization, bulk polymerization, and various radical polymerization methods including emulsion polymerization. The resultant (meth)acryl-based polymer may be any of a random copolymer, a block copolymer, a graft copolymer, or any other form.

Any appropriate polymerization initiator, chain transfer agent, emulsifying agent and so on may be selected and used for radical polymerization. The weight average molecular weight of the (meth)acryl-based polymer may be controlled by the reaction conditions including the amount of addition of the polymerization initiator or the chain transfer agent. The amount of the addition may be controlled as appropriate depending on the type of these materials.

In a solution polymerization process and so on, for example, ethyl acetate, toluene or the like is used as a polymerization solvent. In a specific solution polymerization process, for example, the reaction is performed under a stream of inert gas such as nitrogen at a temperature of about 50 to about 70° C. for about 5 to about 30 hours in the presence of a polymerization initiator.

Examples of the thermal polymerization initiator used for the solution polymerization process include, but are not limited to, azo initiators such as 2,2′-azobisisobutyronitrile, 2,2′-azobis-2-methylbutyronitrile, 2,2′-azobis(2-methylpropionic acid) dimethyl, 4,4′-azobis-4-cyanovaleric acid, azobisisovaleronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057, manufactured by Wako Pure Chemical Industries, Ltd.); persulfates such as potassium persulfate and ammonium persulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The content of the polymerization initiator is preferably from about 0.005 to 1 part by weight, even more preferably from about 0.02 to about 0.5 parts by weight, based on 100 parts by total weight of the monomer component.

For example, when 2,2′-azobisisobutyronitrile is used as a polymerization initiator for the production of the (meth)acryl-based polymer with the above weight average molecular weight, the polymerization initiator is preferably used in a content of from about 0.06 to about 0.2 parts by weight, more preferably of from about 0.08 to about 0.175 parts by weight, based on 100 parts by total weight of the monomer component.

Examples of the chain transfer agent include lauryl mercaptan, glycidyl mercaptan, mercaptoacetic acid, 2-mercaptoethanol, thioglycolic acid, 2-ethylhexyl thioglycolate and 2,3-dimercapto-1-propanol. One of these chain transfer agents may be used alone, or two or more thereof may be used in a mixture. The total content of the chain transfer agent is preferably about 0.1 parts by weight or less, based on 100 parts by total weight of the monomer component.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone, or two or more thereof may be used in combination.

The emulsifier may be a reactive emulsifier. Examples of such an emulsifier having an introduced radical-polymerizable functional group such as a propenyl group and an allyl ether group include Aqualon HS-10, HS-20, KH-10, BC-05, BC-10, and BC-20 (each manufactured by Dai-ichi Kogyo Seiyaku Co., Ltd.) and Adekaria Soap SE10N (manufactured by ADEKA CORPORATION). The reactive emulsifier is preferred, because after polymerization, it can be incorporated into a polymer chain to improve water resistance. Based on 100 parts by total weight of the monomer component, the emulsifier is preferably used in a content of 0.3 to 5 parts by weight, more preferably of 0.5 to 1 part by weight, in view of polymerization stability or mechanical stability.

When the (meth)acryl-based polymer is produced by active energy ray polymerization, the production can be attained by irradiating the monomer component(s) with an active energy ray, such as an electron beam or an ultraviolet ray, to be polymerized. When the active energy ray polymerization is attained using the electron beam, it is not particularly necessary to incorporate a photopolymerization initiator into the monomer component(s). When the active energy ray polymerization is attained through the ultraviolet ray polymerization, a photopolymerization initiator may be incorporated into the monomer component(s) to produce, particularly, an advantage of shortening the polymerization period, and/or some other advantage. The photopolymerization initiator may be used alone or in a mixture of two or more. About the monomer component(s), a part thereof may be beforehand polymerized to be made into a syrup, and in the irradiation with the radial ray, the syrup is usable.

The photopolymerization initiator is not particularly limited as long as it can initiate photopolymerization, and photopolymerization initiators that are usually used can be employed. Examples thereof that can be used include benzoin ether-based photopolymerization initiator, acetophenone-based photopolymerization initiator, α-ketol-based photopolymerization initiator, aromatic sulfonyl chloride-based photopolymerization initiator, photoactive oxime-based photopolymerization initiator, benzoin-based photopolymerization initiator, benzyl-based photopolymerization initiator, benzophenone-based photopolymerization initiator, ketal-based photopolymerization initiator, thioxanthone-based photopolymerization initiator, acylphosphine oxide-based photopolymerization initiator, and the like.

Specific examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (trade name: IRGACURE 651, manufactured by BASF), anisoin methyl ether, and the like. Examples of the acetophenone-based photopolymerization initiator include 1-hydroxycyclohexyl phenyl ketone (trade name: IRGACURE 184, manufactured by BASF), 4-phenoxydichloroacetophenone, 4-t-butyl-dichloroacetophenone, 1-[4-(2-hydroxyethoxy)-phenyl]-2-hydroxy-2-methyl-1-propan-1-one (trade name: IRGACURE 2959, manufactured by BASF), 2-hydroxy-2-methyl-1-phenyl-propan-1-one (tradename: DAROCUR 1173, manufactured by BASF), methoxyacetophenone, and the like. Examples of the α-ketol-based photopolymerization initiator include 2-methyl-2-hydroxypropiophenone, 1-[4-(2-hydroxyethyl)-phenyl]-2-hydroxy-2-methylpropan-1-one, and the like. Examples of the aromatic sulfonyl chloride-based photopolymerization initiator include 2-naphthalene sulfonyl chloride and the like. Examples of the photoactive oxime-based photopolymerization initiator include 1-phenyl-1,2-propanedione-2-(O-ethoxycarbonyl)-oxime, and the like.

Examples of the benzoin-based photopolymerization initiator include benzoin and the like. Examples of the benzyl-based photopolymerization initiator include benzyl and the like. Examples of the benzophenone-based photopolymerization initiators include benzophenone, benzoylbenzoic acid, 3,3′-dimethyl-4-methoxybenzophenone, polyvinylbenzophenone, α-hydroxycyclohexylphenylketone, and the like. Examples of the ketal-based photopolymerization initiator include benzyl dimethyl ketal and the like. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, dodecylthioxanthone and the like.

Examples of the acylphosphine oxide-based photopolymerization initiator include bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropan-1-yl)phosphine oxide, bis(2-methoxybenzoyl)(1-methylpropan-1-yl)phosphine oxide, bis(2,6-diethoxybenzoyl)(2-methylpropan-1-yl)phosphine oxide, bis(2,6-diethoxybenzoyl)(1-methylpropan-1-yl)phosphine oxide, bis(2,6-dibutoxybenzoyl)(2-methylpropan-1-yl)phosphine oxide, bis(2,4-dimethoxybenzoyl)(2-methylpropan-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, tri(2-methylbenzoyl)phosphine oxide, and the like.

The content of the photopolymerization initiator is not particularly limited, but is preferably 0.01 to 5 parts by weight, more preferably 0.05 to 3 parts by weight, furthermore preferably 0.05 to 1.5 parts by weight, and particularly preferably 0.1 to 1 part by weight, based on 100 parts by total weight of the monomer component.

If the photopolymerization initiator is used in an amount of less than 0.01 parts by weight, the polymerization reaction may be insufficient. If the photopolymerization initiator is used in an amount of more than 5 parts by weight, the photopolymerization initiator may absorb ultraviolet rays, so that ultraviolet rays may fail to reach the inside of the pressure-sensitive adhesive layer. In this case, the degree of polymerization may decrease, or a polymer with a lower molecular weight may be produced. This may cause the resulting pressure-sensitive adhesive layer to have lower cohesive strength, so that in the process of peeling off the pressure-sensitive adhesive layer from a film, the pressure-sensitive adhesive layer may partially remain on the film, which may make it impossible to reuse the film. The photopolymerization initiators may be used singly or in combination of two or more.

In the invention, the (meth)acryl-based polymer preferably has a weight average molecular weight of 400,000 to 2,500,000, more preferably 600,000 to 2,200,000. When the weight average molecular weight is more than 400,000, the pressure-sensitive adhesive layer can have satisfactory durability and can have a cohesive strength small enough to suppress adhesive residue. On the other hand, if the weight average molecular weight is more than 2,500,000, bonding ability or adhesive strength may tend to be lower. In this case, the pressure-sensitive adhesive may form a solution with too high a viscosity, which may be difficult to apply. As used herein, the term “weight average molecular weight” refers to a polystyrene-equivalent weight average molecular weight, which is determined using gel permeation chromatography (GPC). It should be noted that the molecular weight of the (meth)acryl-based polymer obtained by radiation polymerization would be difficult to measure.

### <Measurement of Weight Average Molecular Weight>

The weight average molecular weight of the obtained (meth)acryl-based polymer was measured by gel permeation chromatography (GPC) as follows. The polymer sample was dissolved in tetrahydrofuran to form a 0.1% by weight solution. After allowed to stand overnight, the solution was filtered through a 0.45 μm membrane filter, and the filtrate was used for the measurement.

Analyzer: HLC-8120GPC manufactured by TOSOH CORPORATION Columns:

(meth)acryl-based polymer: GM7000H_{xL}+GMH_{xL}+GMH_{xL}, manufactured by TOSOH CORPORATION,

aromatic-based polymer: G3000HXL+2000HXL+G1000HXL, manufactured by TOSOH CORPORATION

Column size: each 7.8 mmφ×30 cm, 90 cm in total
Eluent: tetrahydrofuran (concentration 0.1% by weight)
Flow rate: 0.8 ml/minute
Inlet pressure: 1.6 MPa
Detector: differential refractometer (RI)
Column temperature: 40° C.
Injection volume: 100 μl
Eluent: tetrahydrofuran
Detector: differential refractometer
Standard sample: polystyrene

The pressure-sensitive adhesive used to form the pressure-sensitive adhesive layer A, B of the present invention may contain a crosslinking agent. Examples of the crosslinking agents include an isocyanate crosslinking agent, an epoxy crosslinking agent, a silicone crosslinking agent, an oxazoline crosslinking agent, an aziridine crosslinking agent, a silane crosslinking agent, an alkyl etherified melamine crosslinking agent, a metallic chelate crosslinking agent and a peroxide. Such crosslinking agents may be used alone or in combination of two or more. An isocyanate crosslinking agent or an epoxy crosslinking agent is preferably used as the crosslinking agent.

These crosslinking agents may be used alone or in a mixture of two or more. The total content of the crosslinking agent (s) is preferably 0.01 to 5 parts by weight, more preferably 0.01 to 4 parts by weight, even more preferably 0.02 to 3 parts by weight, based on 100 parts by weight of the (meth)acryl-based polymer.

The term “isocyanate crosslinking agent” refers to a compound having two or more isocyanate groups (which may include functional groups that are temporarily protected with an isocyanate blocking agent or by oligomerization and are convertible to isocyanate groups) per molecule.

Isocyanate crosslinking agents include aromatic isocyanates such as tolylene diisocyanate and xylene diisocyanate, alicyclic isocyanates such as isophorone diisocyanate, and aliphatic isocyanates such as hexamethylene diisocyanate.

More specifically, examples of isocyanate crosslinking agents include lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic diisocyanates such as 2,4-tolylene diisocyanate, 4,4′-diphenylmethane diisocyanate, xylylene diisocyanate, and polymethylene polyphenyl isocyanate; isocyanate adducts such as a trimethylolpropane-tolylene diisocyanate trimer adduct (trade name: CORONATE L, manufactured by NIPPON POLYURETHANE INDUSTRY CO., LTD.), a trimethylolpropane-hexamethylene diisocyanate trimer adduct (trade name: CORONATE HL, manufactured by NIPPON POLYURETHANE INDUSTRY CO., LTD.), and an isocyanurate of hexamethylene diisocyanate (trade name: CORONATE HX, manufactured by NIPPON POLYURETHANE INDUSTRY CO., LTD.); a trimethylolpropane adduct of xylylene diisocyanate (trade name: D110N, manufactured by Mitsui Chemicals, Inc.) and a trimethylolpropane adduct of hexamethylene diisocyanate (trade name: D160N, manufactured by Mitsui Chemicals, Inc.); polyether polyisocyanate and polyester polyisocyanate; adducts thereof with various polyols; and polyisocyanates polyfunctionalized with an isocyanurate bond, a biuret bond, an allophanate bond, or the like. In particular, aliphatic isocyanates are preferably used because of their high reaction speed.

These isocyanate crosslinking agents may be used alone or in a mixture of two or more. The total content of the isocyanate crosslinking agent (s) is preferably 0.01 to 5 parts by weight, more preferably 0.01 to 4 parts by weight, further more preferably 0.02 to 3 parts by weight, based on 100 parts by weight of the (meth)acryl-based polymer. The content may be appropriately determined taking into account cohesive strength, the ability to prevent delamination in a durability test, or other properties.

When an aqueous dispersion of a modified (meth)acryl-based polymer produced by emulsion polymerization is used, the isocyanate crosslinking agent does not have to be used. If necessary, however, a blocked isocyanate crosslinking agent may also be used in such a case, because the isocyanate crosslinking agent itself can easily react with water.

The term “epoxy crosslinking agent” refers to a polyfunctional epoxy compound having two or more epoxy groups per molecule. Examples of the epoxy crosslinking agent include bisphenol A, epichlorohydrin-type epoxy resin, ethylene glycol diglycidyl ether, N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, glycerine diglycidyl ether, glycerine triglycidyl ether, polyglycerol polyglycidyl ether, sorbitan polyglycidyl ether, trimethylolpropane polyglycidyl ether, diglycidyl adipate, diglycidyl o-phthalate, triglycidyl tris(2-hydroxyethyl)isocyanurate, resorcin diglycidyl ether, bisphenol-S diglycidyl ether, and epoxy resins having two or more epoxy groups in the molecule. The epoxy crosslinking agent may also be a commercially available product such as TETRAD-C (trade name) or TETRAD-X (trade name) manufactured by MITSUBISHI GAS CHEMICAL COMPANY, INC.

These epoxy crosslinking agents may be used alone or in a mixture of two or more. The total content of the epoxy crosslinking agent(s) is preferably 0.01 to 5 parts by weight, more preferably 0.01 to 4 parts by weight, further more preferably 0.02 to 3 parts by weight, based on 100 parts by weight of the (meth)acryl-based polymer. The content may be appropriately determined taking into account cohesive strength, the ability to prevent delamination in a durability test, or other properties.

Any peroxide crosslinking agents capable of generating active radical species by heating and promoting the crosslinking of the base polymer in the pressure-sensitive adhesive may be appropriately used. In view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide for use in the invention include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoylperoxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can provide high crosslinking reaction efficiency.

The half life of the peroxide is an indicator of how fast the peroxide can be decomposed and refers to the time required for the amount of the peroxide to reach one half of its original value. The decomposition temperature required for a certain half life and the half life time obtained at a certain temperature are shown in catalogs furnished by manufacturers, such as “Organic Peroxide Catalog, 9th Edition, May, 2003” furnished by NOF CORPORATION.

One of the peroxide crosslinking agents may be used alone, or a mixture of two or more of the peroxide crosslinking agent may be used. The total content of the peroxide (s) is preferably from 0.02 to 2 parts by weight, more preferably from 0.05 to 1 part by weight, based on 100 parts by weight of the (meth) acryl-based polymer. The content of the peroxide (s) may be appropriately selected in this range in order to control the workability, reworkability, crosslink stability or peeling properties.

The amount of decomposition of the peroxide may be determined by measuring the peroxide residue after the reaction process by high performance liquid chromatography (HPLC).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

As the crosslinking agent, a polyfunctional metal chelate may also be used in combination with an organic crosslinking agent. Examples of the polyfunctional metal chelate may include a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The pressure-sensitive adhesive that forms each of the pressure-sensitive adhesive layers A and B in the present invention may contain, as the crosslinking agent, a polyfunctional monomer. The polyfunctional monomer is a monomer having at least two polymerizable functional groups with an unsaturated double bond such as (meth)acryloyl group or vinyl group. Examples thereof are the same as given as the monomer component or one of the monomer components for forming the (meth)acryl-based polymer.

The polyfunctional monomers, as the crosslinking agent, may be used alone or in a mixture of two or more. The total content of the crosslinking agent (polyfunctional monomer) is preferably from 0.001 to 5 parts by weight, more preferably from 0.005 to 3 parts by weight, even more preferably from 0.01 to 1 part by weight based on 100 parts by weight of the (meth)acryl-based polymer.

A photopolymerization initiator is blended into the pressure-sensitive adhesive into which the crosslinking agent (polyfunctional monomer) is blended. Examples of the photopolymerization initiator are the same as used to prepare the (meth)acryl-based polymer. The use amount of the photopolymerization initiator is usually from 0.01 to 5 parts by weight, preferably from 0.05 to 3 parts by weight, more preferably from 0.05 to 1.5 parts by weight, even more preferably from 0.1 to 1 part by weight based on 100 parts by weight of the crosslinking agent (polyfunctional monomer). The pressure-sensitive adhesive into which the crosslinking agent (polyfunctional monomer) is blended is irradiated with an active energy ray to be cured so that a pressure-sensitive adhesive layer (active-energy-ray-cured-pressure-sensitive adhesive layer) is formed.

About the multiple pressure-sensitive adhesive layer, which is the pressure-sensitive adhesive layer A, at least one of the pressure-sensitive adhesive layers thereof is preferably an active-energy-ray-cured-pressure-sensitive adhesive layer formed by irradiation with an active energy ray from the viewpoint of the step-absorbing capability thereof. The first pressure-sensitive adhesive layer (a) and/or the second pressure-sensitive adhesive layer (b) is/are in particular preferably one or two active energy ray cured adhesive layers.

It is preferred that the first, second and third pressure-sensitive adhesive layers (a), (b) and (c) of the pressure-sensitive adhesive layer A each contain, as monomer units, specifically, butyl acrylate and/or 2-ethylhexyl acrylate as one or more main components and a hydroxyl-group-containing monomer and/or a carboxyl-group-containing monomer as one or more copolymerizable monomers. For the pressure-sensitive adhesive layer B, it is preferred to use a thermosetting adhesive containing, specifically, butyl acrylate as a main component.

The pressure-sensitive adhesive used to form the pressure-sensitive adhesive layer A, B of the present invention may contain a (meth)acryl-based oligomer in view of improving adhesive strength. The (meth)acryl-based oligomer is preferably a polymer having a Tg higher than that of the (meth)acryl-based polymer according to the invention and having a weight average molecular weight lower than that of the (meth)acryl-based polymer according to the invention. The (meth)acryl-based oligomer functions as a tackifying resin and is advantageous in increasing adhesive strength without raising dielectric constant.

The (meth)acryl-based oligomer may have a Tg of from about 0° C. to about 300° C., preferably from about 20° C. to about 300° C., more preferably from about 40° C. to about 300° C. If the Tg is lower than about 0° C., the pressure-sensitive adhesive layer may be lowered in cohesive strength at room temperature or higher so as to be lowered in holding performance or in tackiness at high temperatures. Like the Tg of the (meth)acryl-based polymer, the Tg of the (meth)acryl-based oligomer is the theoretical value calculated from the Fox equation.

The (meth)acryl-based oligomer may have a weight average molecular weight of 1,000 to less than 30,000, preferably 1,500 to less than 20,000, more preferably 2,000 to less than 10,000. If the oligomer has a weight average molecular weight of 30,000 or more, the effect of improving adhesive strength cannot be sufficiently obtained in some cases. The oligomer with a weight average molecular weight of less than 1,000 may lower the adhesive strength or holding performance because of its relatively low molecular weight. In the invention, the weight average molecular weight of the (meth)acryl-based oligomer can be determined as a polystyrene-equivalent weight average molecular weight by GPC method. More specifically, the weight average molecular weight can be determined using HPLC 8020 with two TSKgel GMH-H (20) columns manufactured by TOSOH CORPORATION under the conditions of a solvent of tetrahydrofuran and a flow rate of about 0.5 ml/minute.

Examples of monomers that may be used to form the (meth)acryl-based oligomer include alkyl (meth)acrylate such as methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, isopentyl (meth)acrylate, hexyl (meth)acrylate, 2-ethylhexyl (meth)acrylate, heptyl (meth)acrylate, octyl (meth)acrylate, isooctyl (meth)acrylate, nonyl (meth)acrylate, isononyl (meth)acrylate, decyl(meth)acrylate, isodecyl(meth)acrylate, undecyl (meth)acrylate, or dodecyl (meth)acrylate; an ester of (meth)acrylic acid and an alicyclic alcohol, such as cyclohexyl (meth)acrylate, isobornyl (meth)acrylate or dicyclopentanyl (meth)acrylate; aryl (meth)acrylate such as phenyl (meth)acrylate or benzyl (meth)acrylate; and a (meth)acrylate derived from a terpene compound derivative alcohol. These (meth)acrylates may be used alone or in combination of two or more.

The (meth)acryl-based oligomer preferably contains, as a monomer unit, an acrylic monomer having a relatively bulky structure, typified by an alkyl (meth)acrylate whose alkyl group has a branched structure, such as isobutyl (meth)acrylate or tert-butyl (meth)acrylate; an ester of (meth)acrylic acid and an alicyclic alcohol, such as cyclohexyl (meth)acrylate or isobornyl (meth)acrylate; or aryl (meth)acrylate such as phenyl (meth)acrylate or benzyl (meth)acrylate, or any other cyclic structure-containing (meth)acrylate. The use of a (meth)acryl-based oligomer with such a bulky structure can further improve the tackiness of the pressure-sensitive adhesive layer. In terms of bulkiness, cyclic structure-containing oligomers are highly effective, and oligomers having two or more rings are more effective. When ultraviolet light is used in the process of synthesizing the (meth)acryl-based oligomer or forming the pressure-sensitive adhesive layer, a saturated oligomer is preferred because such an oligomer is less likely to inhibit polymerization, and an alkyl (meth)acrylate whose alkyl group has a branched structure or an ester of an alicyclic alcohol and (meth)acrylic acid is preferably used as a monomer to form the (meth)acryl-based oligomer.

From these points of view, preferred examples of the (meth)acryl-based oligomer include a copolymer of cyclohexyl methacrylate (CHMA) and isobutyl methacrylate (IBMA), a copolymer of cyclohexyl methacrylate (CHMA) and isobornyl methacrylate (IBXMA), a copolymer of cyclohexyl methacrylate (CHMA) and acryloyl morpholine (ACMO), a copolymer of cyclohexyl methacrylate (CHMA) and diethylacrylamide (DEAA), a copolymer of 1-adamanthyl acrylate (ADA) and methyl methacrylate (MMA), a copolymer of dicyclopentanyl methacrylate (DCPMA) and isobornyl methacrylate (IBXMA), a copolymer of dicyclopentanyl methacrylate (DCPMA) and methyl methacrylate (MMA), and a homopolymer of each of dicyclopentanyl methacrylate (DCPMA), cyclohexyl methacrylate (CHMA), isobornylmethacrylate (IBXMA), isobornyl acrylate (IBXA), dicyclopentanyl acrylate (DCPA), 1-adamanthyl methacrylate (ADMA), and 1-adamanthyl acrylate (ADA). In particular, an oligomer composed mainly of CHMA is preferred.

In the pressure-sensitive adhesive used to form the pressure-sensitive adhesive layer A, B of the present invention, the content of the (meth)acryl-based oligomer is preferably, but not limited to, 70 parts by weight or less, more preferably from 1 to 70 parts by weight, even more preferably from 2 to 50 parts by weight, still more preferably from 3 to 40 parts by weight, based on 100 parts by weight of the (meth)acryl-based polymer. If the content of the (meth)acryl-based oligomer is more than 70 parts by weight, a problem may occur such as an increase in elastic modulus or a decrease in tackiness at low temperature. Adding 1 part by weight or more of the (meth)acryl-based oligomer is effective in improving adhesive strength.

The pressure-sensitive adhesive used to form the pressure-sensitive adhesive layer A, B of the present invention may further contain a silane coupling agent for improving water resistance at the interface between the pressure-sensitive adhesive layer and a hydrophilic adherend, such as glass, bonded thereto. The content of the silane coupling agent is preferably 1 part by weight or less, more preferably from 0.01 to 1 part by weight, even more preferably from 0.02 to 0.6 parts by weight, based on 100 parts by weight of the (meth)acryl-based polymer. If the content of the silane coupling agent is too high, the adhesive may have a higher adhesive strength to glass so that it may be less removable from glass. If the content of the silane coupling agent is too low, the durability of the adhesive may undesirably decrease.

Examples of silane coupling agent preferably can be used include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, 3-triethoxysilyl-N-(1,3-dimethylbutylidene)propylamine and N-phenyl-γ-aminopropyltrimethoxysilane; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane.

The pressure-sensitive adhesive used to form the pressure-sensitive adhesive layer A, B of the present invention may also contain any other known additive. For example, a polyether compound such as a polyalkylen glycol exemplified a polypropylene glycol, a powder such as a colorant and a pigment, a dye, a surfactant, a plasticizer, a tackifier, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use. A redox system including an added reducing agent may also be used in the controllable range.

For example, the pressure-sensitive adhesive layers A, B may be formed by a method including applying the formation material (pressure-sensitive adhesive) to a member such as a transparent substrate and/or a polarizing film, removing the polymerization solvent and so on by drying to form a pressure-sensitive adhesive layers. Before the formation material is applied, appropriately at least one solvent other than the polymerization solvent may be added to the formation material.

Various methods may be used to apply the formation material. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The heat drying temperature is preferably from 40° C. to 200° C., more preferably from 50° C. to 180° C., in particular, preferably from 70° C. to 170° C. Setting the heating temperature within the above range makes it possible to obtain a pressure-sensitive adhesive layer A or B having good adhesive properties. The drying time may be any appropriate period of time. The drying time is preferably from 5 seconds to 20 minutes, more preferably from 5 seconds to 10 minutes, in particular, preferably from 10 seconds to 5 minutes.

When the formation material (pressure-sensitive adhesive) is an active energy ray curing adhesive, the formation of the pressure-sensitive adhesive layers A and B can be attained by irradiating the material with an active energy ray, such as an ultraviolet ray, to be polymerized. For the ultraviolet irradiation, for example, a high-pressure mercury lamp, a low-pressure mercury lamp, or a metal halide lamp is usable.

The pressure-sensitive adhesive layers A and B may be formed onto a support, and then transferred onto, for example, a polarizing film. The support may be, for example, a release-treated sheet. A silicone release liner is preferably used as the release-treated sheet. About the multiple pressure-sensitive adhesive layer, which is the pressure-sensitive adhesive layer A, the first and second pressure-sensitive adhesive layers (a) and (b), and others may be formed successively onto the release-treated sheet, and the resultant may be bonded onto a polarizing film. Alternatively, the first and second pressure-sensitive adhesive layers (a) and (b), and others that are separately formed may be successively formed onto a polarizing film to position the first pressure-sensitive adhesive layer (a) to give an outermost surface of the resultant.

In the pressure-sensitive adhesive sheet include the layer pressure-sensitive adhesive layer A or B formed on the release-treated sheet, when the pressure-sensitive adhesive layer is exposed, the pressure-sensitive adhesive layer may be protected with the release-treated sheet (a separator) before practical use. The release-treated sheet is peeled off before actual use.

Examples of the material for forming the separator include a plastic film such as a polyethylene, polypropylene, polyethylene terephthalate, or polyester film, a porous material such as paper, cloth and nonwoven fabric, and an appropriate thin material such as a net, a foamed sheet, a metal foil, and a laminate thereof. In particular, a plastic film is preferably used, because of its good surface smoothness.

The plastic film may be any film capable of protecting the pressure-sensitive adhesive layer A or B, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is generally from about 5 to about 200 μm, preferably from about 5 to about 100 μm. If necessary, the separator may be treated with a release agent such as a silicone, fluorine, long-chain alkyl, or fatty acid amide release agent, or may be subjected to release and antifouling treatment with silica powder or to antistatic treatment of coating type, kneading and mixing type, vapor-deposition type, or the like. In particular, if the surface of the separator is appropriately subjected to release treatment such as silicone treatment, long-chain alkyl treatment, and fluorine treatment, the releasability from the pressure-sensitive adhesive layer A or B can be further increased.

When the pressure-sensitive adhesive layers A and B are located onto the polarizing film, one or each of the two surfaces of the polarizing film may be subjected to adhesion-facilitating treatment. Examples of the adhesion-facilitating treatment include corona treatment, plasma treatment, excimer treatment, and hard coat treatment. One or each of the two surfaces of any one of the pressure-sensitive adhesive layers may be subjected to adhesion-facilitating treatment. In the pressure-sensitive-adhesive-layer-attached polarizing film of the present invention, the surface of its polarizing film onto which the pressure-sensitive adhesive layer A is to be laminated is preferably subjected to adhesion-facilitating treatment from the viewpoint of a restraint of the generation of foam and peeling.

The pressure-sensitive-adhesive-layer-attached polarizing film of the present invention may be prepared to have, at any moiety thereof, an antistatic function. The antistatic function can be given to the pressure-sensitive-adhesive-layer-attached polarizing film, for example, by incorporating, into its polarizing film or pressure-sensitive adhesive layer(s), an antistatic agent, or by laying an antistatic layer separately from its polarizing film or pressure-sensitive adhesive layers. The formation of the antistatic layer may be according to, for example, a method of using a composition containing a conductive polymer, such as polythiophene, and a binder to form the antistatic layer between the polarizing film and any one or each of the pressure-sensitive adhesive layer(s).

The pressure-sensitive adhesive layer A of the pressure-sensitive-adhesive-layer-attached polarizing film of the present invention is arranged in an image display device (for example, a liquid crystal display device), and at a viewer-side thereof and outside (viewer-side) the polarizing film which is provided nearest to a viewer-side of an image display device among at least one polarizing film used in the device. Accordingly, for example, the following problem of a fall in optical properties of the device can be largely overcome: a problem that the cancelling of light polarization, or impurity-based bright spots that may be generated when an antistatic layer (low-surface-resistance layer) between the viewer-side polarizing film and a panel of the liquid crystal. Thus, the reliability of the polarizing film arranged at the viewer-side and at the outermost position of the device is not damaged. In such a way, the invention makes it possible to give an antistatic function to an image display device without damaging performance thereof.

In the case of applying a technique of laying an antistatic layer onto a polarizing plate to an in-cell type or on-cell type touch-sensor-built-in liquid crystal display device, the technique is particularly effective for preventing image noises based on static electricity. Thus, the present invention makes it possible to heighten the quality of any in-cell type or on-cell type touch-sensor-built-in liquid crystal display device.

In order to give antistatic function to the pressure-sensitive adhesive that forms the pressure-sensitive adhesive layers A and B in the present invention, an ionic compound as an antistatic agent is incorporated, together with the base polymer, into the adhesive. The ionic compound is preferably an alkali metal salt and/or an organic-cation/anion salt. The alkali metal salt may be an organic salt or inorganic salt of an alkali metal. The “organic-cation/anion salt” referred to in the present invention denotes an organic salt in which a cation moiety is made of an organic substance and an anion moiety is made of an organic or inorganic substance. The “organic-cation/anion salt” may be referred to as an ionic liquid or ionic solid.

The ionic compound may be an inorganic salt, such as ammonium chloride, aluminum chloride, copper chloride, ferrous chloride, ferric chloride, or ammonium sulfate, besides the alkali metal salt or organic-cation/anion salt. These ionic compounds may be singly used, or may be used in combination of two or more thereof.

The amount of the ionic compound in the pressure-sensitive adhesive for forming each of the pressure-sensitive adhesive layers A and B in the present invention is preferably from 0.0001 to 5 parts by weight based on 100 parts by weight of the (meth)acryl-based polymer. If the amount of the ionic compound is less than 0.0001 part by weight, the layer may not have a sufficient antistatic effect. The amount of the ionic compound is preferably 0.01 part by weight or more, more preferably 0.1 part by weight or more. In the meantime, if the amount of the ionic compound is more than 5 parts by weight, the layer may not have a sufficient durability. The amount of the ionic compound is preferably 3 parts by weight or less, more preferably 1 part by weight or less. The content of the ionic compound can be set into a preferred range by adopting the upper limit or lower limit value.

### EXAMPLES

Hereinafter, the present invention will be specifically described by way of working examples thereof. However, the invention is not limited by the examples. In each of the examples, the wording “part (s)” and the symbol “%” represent part(s) by weight and % by weight, respectively. The following estimations were made on each of the items in Examples and so on.

### Production Example 1

Into a separable flask equipped with a thermometer, a stirrer, a reflux condenser and a nitrogen gas introducing pipe were charged 95 parts of butyl acrylate (BA), and 5 parts of acrylic acid (AA) as monomer components, 0.2 part of azoisobutyronitrile as a polymerization initiator, and ethyl acetate as a polymerizing solvent, the volume of which was a volume for setting the solid concentration in the solution into 30%. Thereafter, nitrogen gas was caused to flow into the pipe, and then the flask was purged with nitrogen for about 1 hour while the solution was stirred. The flask was then heated to 60° C. to cause the components to react with each other for 7 hours to yield an acryl-based polymer having a weight average molecular weight (Mw) of 1/100,000. To the acryl-based polymer solution (solid content: 100 parts) were added 0.8 part of trimethylolpropanetolylene diisocyanate (“CORONATE L”, manufactured by Nippon Polyurethane Industry Co., Ltd.) as an isocyanate crosslinking agent, and 0.1 part of a silane coupling agent (“KBM-403”, manufactured by Shin-Etsu Chemical Co., Ltd.) to prepare a pressure-sensitive adhesive composition (solution). The prepared pressure-sensitive adhesive solution was applied onto polyethylene terephthalate release liners each having a thickness of 35 μm to give thicknesses of 20 μm, 25 μm and 150 μm, respectively, after the resultants would be dried. The resultants were thermally dried at 60° C. for 3 minutes and at 120° C. for 3 minutes, and further aged at 23° C. for 120 hours, under an ambient pressure, to produce pressure-sensitive adhesive layers. The respective pressure-sensitive adhesive layers would be used as a first or third pressure-sensitive adhesive layer (a-1) or (c-1) of pressure-sensitive adhesive layer A.

### Production Example 2

Prepared was an acryl-based polymer A (Mw=500000) obtained by random-copolymerizing 85 parts of 2-ethylhexyl acrylate (2EHA), 10 parts of vinyl acetate (VA) and 5 parts of acrylic acid (AA). Into 100 parts of the acryl-based polymer A were blended 15 parts of an ultraviolet curing resin (propoxylated pentaerythritol triacrylate) as a crosslinking agent, and 0.7 part of 4-methylbenzophenone as a photopolymerization initiator to prepare an active-energy-ray-curable-pressure-sensitive adhesive composition. An applicator was used to apply this active-energy-ray-curable-pressure-sensitive adhesive composition onto release-treated polyethylene terephthalate films (thickness: 75 μm) to give thicknesses of 25 μm, 100 μm and 150 μm, respectively, and then the respective front surfaces of the resultants were each covered with a release-treated polyethylene terephthalate film (“E7006”, manufactured by Toyobo Co., Ltd.; thickness: 38 μm). High-pressure mercury lamps were used to radiate ultraviolet rays having an integrated illuminance of 1000 mJ/cm² onto the front and rear sides of each of the resultants across the polyethylene terephthalate films. In this way, the active-energy-ray-curable-pressure-sensitive adhesive composition was crosslinked to produce active-energy-ray-cured-pressure-sensitive adhesive layers having thicknesses of 25 μm, 100 μm and 150 μm, respectively. These adhesive layers would each be used as a first or third pressure-sensitive adhesive layer (a-2) or (c-2) of the pressure-sensitive adhesive layer A.

### Production Example 3

Into a separable flask equipped with a thermometer, a stirrer, a reflux condenser and a nitrogen gas introducing pipe were charged 80 parts of 2-ethylhexyl acrylate (2EHA), 10 parts of N-vinyl-2-pyrrolidone (NVP), and 10 parts of 4-hydroxybutyl acrylate (4HBA) as monomer components, 0.2 part of 2,2′-azoisobutyronitrile as a polymerization initiator, and 133 parts of ethyl acetate as a polymerizing solvent. While nitrogen gas was caused to flow into the pipe, the solution was stirred for 1 hour. After oxygen inside the polymerizing system was removed in this way, the temperature of the system was raised to 65° C. to cause the components to react with each other for 10 hours. Thereafter, ethyl acetate was added thereto to yield an acryl-based polymer solution having a solid concentration of 30%. To the acryl-based polymer solution were added an isocyanate crosslinking agent (“TAKENATE D110N”, manufactured by Mitsui Chemicals, Inc.) as a crosslinking agent in an amount of 0.2 part, and γ-glycydoxypropyltrimethoxysilane (“KBM-403”, manufactured by Shin-Etsu Chemical Co., Ltd.) as a silane coupling agent in an amount of 0.3 part, based on 100 parts of the acryl-based polymer in the solution. These components were mixed with each other to prepare a pressure-sensitive adhesive composition (solution). Next, the pressure-sensitive adhesive solution was applied onto the release-treated surface of a release liners (trade name: “MRF75”, manufactured by Mitsubishi Plastics, Inc.) to give thicknesses of 110 μm and 150 μm, respectively, after the resultants would be dried. The resultants were thermally dried at 60° C. for 3 minutes and at 120° C. for 3 minutes and further aged at 23° C. for 120 hours, under an ambient pressure, to produce pressure-sensitive adhesive layers. These pressure-sensitive adhesive layers would each be used as a second pressure-sensitive adhesive layer (b-1) of the pressure-sensitive adhesive layer A.

### Production Example 4

To 100 parts of the same acryl-based polymer A as used in Production Example 2 were added and incorporated 10 parts of pentaerythritol triacrylate as a crosslinking agent and 2 parts of 4-methylbenzophenone as a photopolymerization initiator to prepare an active-energy-ray-curable-pressure-sensitive adhesive composition. An applicator was used to apply this active-energy-ray-curable-pressure-sensitive adhesive composition onto release-treated polyethylene terephthalate films (thickness: 75 μm) to give thicknesses of 50, 100 and 150 μm, respectively, and then the respective front surfaces of the resultants were each covered with a release-treated polyethylene terephthalate film (trade name: “E7006”, manufactured by Toyobo Co., Ltd.; thickness: 38 μm). High-pressure mercury lamps were used to radiate ultraviolet rays having an integrated illuminance of 1000 mJ/cm² onto the front and rear sides of each of the resultants across the polyethylene terephthalate films. In this way, the active-energy-ray-curable-pressure-sensitive adhesive composition was crosslinked to produce active-energy-ray-cured-pressure-sensitive adhesive layers having thicknesses of 50 μm, 100 μm and 150 μm, respectively. The adhesive layers would each be used as a second pressure-sensitive adhesive layer (b-2) of the pressure-sensitive adhesive layer A.

### Production Example 5

Into a separable flask equipped with a thermometer, a stirrer, a reflux condenser and a nitrogen gas introducing pipe were charged 80 parts of 2-ethylhexyl acrylate (2EHA), 10 parts of N-vinyl-2-pyrrolidone (NVP), and 10 parts of 4-hydroxybutyl acrylate (4HBA) as monomer components, 0.2 part of 2,2′-azoisobutyronitrile as a polymerization initiator, and 133 parts of ethyl acetate as a polymerizing solvent. While nitrogen gas was caused to flow into the pipe, the solution was stirred for 1 hour. After oxygen inside the polymerizing system was removed in this way, the temperature of the system was raised to 65° C. to cause the components to react with each other for 10 hours. Thereafter, ethyl acetate was added thereto to yield an acryl-based polymer solution having a solid concentration of 30%. To the acryl-based polymer solution were added an isocyanate crosslinking agent (“TAKENATE D110N”, manufactured by Mitsui Chemicals, Inc.) as a crosslinking agent in an amount of 0.2 part, γ-glycydoxypropyltrimethoxysilane (“KBM-403”, manufactured by Shin-Etsu Chemical Co., Ltd.) as a silane coupling agent in an amount of 0.3 part, polypropylene glycol diacrylate (molecular weight: 536, trade name: “APG-400”, manufactured by Shin-Nakamura Chemical Co., Ltd.) as a polyfunctional monomer in an amount of 10 parts and hydroxycyclohexyl phenyl ketone (trade name: IRGACURE 184, manufactured by BASF) as a photopolymerization initiator in an amount of 0.2 part based on 100 parts of the acryl-based polymer in the solution. These components were mixed with each other to prepare a pressure-sensitive adhesive composition (solution). Next, the pressure-sensitive adhesive solution was applied onto the release-treated surface of a release liners (trade name: “MRF75”, manufactured by Mitsubishi Plastics, Inc.) to give thickness of 150 μm, after the resultant would be dried. The resultant was thermally dried at 60° C. for 3 minutes and at 120° C. for 3 minutes, and further aged at 23° C. for 120 hours, under an ambient pressure, to produce pressure-sensitive adhesive layers. This pressure-sensitive adhesive layer would be used as a second pressure-sensitive adhesive layer (b-3) of the pressure-sensitive adhesive layer A.

### Production Example 6

### Preparation of Pressure-Sensitive Adhesive Layer B1

Into a separable flask equipped with a thermometer, a stirrer, a reflux condenser and a nitrogen gas introducing pipe were charged 99 parts of butyl acrylate (BA), and 1 part of 4-hydroxybutyl acrylate (4HBA) as monomer components, 0.2 part of azoisobutyronitrile as a polymerization initiator, and ethyl acetate as a polymerizing solvent, the volume of which was a volume for setting the solid concentration in the solution into 20%. Thereafter, nitrogen gas was caused to flow into the pipe, and then the flask was purged with nitrogen for about 1 hour while the solution was stirred. The flask was then heated to 60° C. to cause the components to react with each other for 7 hours to yield an acryl-based polymer having a weight average molecular weight (Mw) of 1/100,000. To the acryl-based polymer solution (solid content: 100 parts) were added 0.8 part of trimethylolpropanetolylene diisocyanate (“CORONATE L”, manufactured by Nippon Polyurethane Industry Co., Ltd.) as an isocyanate crosslinking agent, and 0.1 part of a silane coupling agent (“KBM-403”, manufactured by Shin-Etsu Chemical Co., Ltd.) to prepare a pressure-sensitive adhesive composition (solution). The prepared pressure-sensitive adhesive solution was applied onto polyethylene terephthalate release liners each having a thickness of 38 μm to give each thicknesses of 20 μm, after the resultants would be dried. The resultants were thermally dried at 60° C. for 1 minute and at 150° C. for 1 minute under an ambient pressure to produce pressure-sensitive adhesive layers. These pressure-sensitive adhesive layers would be used as a pressure-sensitive adhesive layer B1.

### Production Example 7

### Preparation of Pressure-Sensitive Adhesive Layer B2

Into 100 parts of (solids in) the same acryl-based polymer as used in Production Example 6 were blended 0.2 part of ethylmethyl pyrrolidinium-bis(trifluoromethanesulfonyl)imide (manufactured by Tokyo Chemical Industry Co., Ltd.) and 0.2 part of lithiumbis(trifluoromethanesulfonyl)imide (manufactured by Mitsubishi Materials Electronic Chemicals Co., Ltd.). Furthermore, thereto were added 0.8 part of trimethylolpropanetolylene diisocyanate (“CORONATE L”, manufactured by Nippon Polyurethane Industry Co., Ltd.) as an isocyanate crosslinking agent, and 0.1 part of a silane coupling agent (“KBM-403”, manufactured by Shin-Etsu Chemical Co., Ltd.) to prepare a pressure-sensitive adhesive composition (solution). The prepared pressure-sensitive adhesive solution was applied onto polyethylene terephthalate release liners each having a thickness of 38 μm to give each thicknesses of 20 μm after the resultants would be dried. The resultants were thermally dried at 60° C. for 1 minutes and at 150° C. for 1 minutes under an ambient pressure to produce pressure-sensitive adhesive layers. These pressure-sensitive adhesive layers would each be used as a pressure-sensitive adhesive layer B2.

### <<Production of Polarizing Film P1>>

An 80 μm-thick polyvinyl alcohol film was stretched to 3 times between rolls different in velocity ratio, while it was dyed in a 0.3% iodine solution at 30° C. for 1 minute. The film was then stretched to a total stretch ratio of 6 times, while it was immersed in an aqueous solution containing 4% of boric acid and 10% of potassium iodide at 60° C. for 0.5 minutes. The film was then washed by immersion in an aqueous solution containing 1.5% of potassium iodide at 30° C. for 10 seconds and then dried at 50° C. for 4 minutes to give a polarizer with a thickness of 20 μm. A 40 μm thick saponified triacetylcellulose film and a 20 μm thick acrylic film were bonded to both sides of the polarizer with a polyvinyl alcohol adhesive to form a polarizing film (hereinafter, the resultant film will be referred to as the polarizing film P1).

### <<Production of Polarizing Film P2>>

An antistatic layer composed mainly of poly(3,4-ethylenedioxythiophene) and polystyrenesulfonic acid was formed onto the polarizing film P1 at the acrylic film side thereof (hereinafter, the resultant film will be referred to as the polarizing film P2). The antistatic layer is shown as “Antistatic layer 1” in Table 1.

### <<Production of Polarizing Film P3>>

A hard coat treatment described below was subjected to the polarizing film P1 at the triacetylcellulose film side thereof. The hard coat treatment was conducted according to the following method:

The following were used: 100 parts of a urethane acrylate made from a pentaerythritol type acrylate and hydrogenated xylene diisocyanate as a urethane acrylate; 49 parts of dipentaerythritol hexaacrylate, 41 parts of pentaerythritol tetraacrylate, and 24 parts of pentaerythritol triacrylate as polyol (meth)acrylates; 59 parts of a (meth)acryl-based polymer having 2-hydroxyethyl groups and 2,3-dihydroxypropyl groups as a (meth)acryl-based polymer having an alkyl group having two or more hydroxyl groups; a polymerization initiator (IRGACURE 184), the amount thereof being 3 parts for the whole of the parts of the entire resin components; and a reactive levelling agent, the amount thereof being 0.5 part therefor. These were diluted with a mixed solvent of butyl acetate and ethyl acetate in which the ratio of the former to the latter was 46/54 (the ratio of the ethyl acetate in the entire solvents: 54%) to give a solid concentration of 50% to prepare a hard-coat-layer-forming material. The reactive levelling agent was a copolymer obtained by copolymerizing dimethylsiloxane, hydroxypropylsiloxane, 6-isocyanate hexylisocyanuric acid, an aliphatic polyester (ratio by mole therebetween: 6.3/1.0/2.2/1.0).

A bar coater was used to paint the hard-coat-layer-forming material onto the triacetylcellulose film of the polarizing film P1, and heated at 100° C. for 1 minute to be dried. Thereafter, a metal halide lamp was used to radiate ultraviolet ray having an integrated illuminance of 300 mJ/cm² onto the resultant to be cured to produce 5 μm-thick hard-coat-attached polarizing film (hereinafter, the resultants film were referred to as the polarizing films P3). The front surface of the hard coat layer was 4H in pencil hardness.

### Example 1

### Production of Pressure-Sensitive-Adhesive-Layer-Attached Polarizing Film

The pressure-sensitive adhesive layer B1 was transferred onto one of the two surfaces (the antistatic layer 1 surface of the acrylic film) of the polarizing film P2 (size: a length of 150 mm×a width of 70 mm). In the meantime, the second pressure-sensitive adhesive layer (b-1) produced in Production Example 3, which had a thickness of 150 μm, was transferred onto the other surface (at the triacetylcellulose film side) of the polarizing film P2, and then the release liner was peeled away. Next, the first pressure-sensitive adhesive layer (a-1) produced in Production Example 1, which had a thickness of 20 μm, was transferred onto the second pressure-sensitive adhesive layer (b-1) to form a multiple pressure-sensitive adhesive layer (pressure-sensitive adhesive layer A) having the two layers. In this way, pressure-sensitive-adhesive-layer-attached polarizing film was produced.

The second pressure-sensitive adhesive layer (b-1) and the first pressure-sensitive adhesive layer (a-1) were made into a state of being protruded from the edge of the polarizing plate by pressurization to set the distance X related to the first pressure-sensitive adhesive layer (a-1) and that Y related to the second pressure-sensitive adhesive layer (b-1) to 20 μm and 120 μm, respectively, the distances being shown in FIG. 2, about the four sides of the polarizing film P2. Thereafter, the protruded portions were cut to be worked. In this way, the layers (b-1) and (a-1) were controlled.

### Examples 2 to 14, and Comparative Examples 1 to 3

In each of the examples, each pressure-sensitive-adhesive-layer-attached polarizing film was produced by the same operations as in Example 1 except that the following factors or some of the factors were changed into those shown in Table 1: the type of the polarizing film, the type and the thickness of each of the layers of the pressure-sensitive adhesive layer A, the distances X and Y, the fact as to whether or not the adhesion-facilitating layer was laid onto the polarizing film surface on which the pressure-sensitive adhesive layer A was to be laid, and the type of the easily-bonding layer, and the type of the pressure-sensitive adhesive layer B. In Example 10, the pressure-sensitive adhesive layer B2 was transferred onto the acrylic film side of the polarizing film P2. This pressure-sensitive adhesive layer B2 is shown as “Antistatic layer 2” in Table 1.

About some of the pressure-sensitive adhesive layers A, some of the pressure-sensitive adhesive layers B, and some of the pressure-sensitive-adhesive-layer-attached polarizing films (any one of these films=any measuring sample with the separator (release liner)) yielded in each of Production Examples, Examples and Comparative Examples described above, the following estimations were made. The estimation results are shown in Table 1.

### <Measurement of Shear Storage Modulus>

The shear storage modulus at 23° C. of each of the pressure-sensitive adhesive layers A and B of the measuring sample was obtained by dynamic viscoelasticity measurement. A dynamic viscoelascity measuring instrument (instrument name: “ARES”, manufactured by a company, TA Instruments) was used to measure the pressure-sensitive adhesive layers A and B of the measuring sample at a frequency of 1 Hz, a range of temperatures of −20 to 100° C., and a temperature-raising rate of 5° C./minute to calculate out the shear storage modulus at 23° C.

### <Measurement of Gel Fraction>

From each of the pressure-sensitive adhesive layers A and B of the measuring sample, a specimen having a predetermined quantity (first weight W1) was taken out, and then immersed into an ethyl acetate solvent. This system was allowed to stand still at room temperature for one week, and then an insoluble matter therein was taken out. The matter was dried, and the dry weight (W2) thereof was measured. The gel fraction in each of the layers was obtained in accordance with the following: “gel fraction”=W2/W1×100.

The pressure-sensitive adhesive layer A side of the pressure-sensitive-adhesive-layer-attached polarizing film of the measuring sample was bonded to a cover glass (having a thickness of 0.7 mm and made of non-alkali glass (1737, manufactured by Corning Inc.), and then a high-pressure mercury lamp was used to radiate ultraviolet rays having an integrated illuminance of 1000 mJ/cm² again onto this bonded body from the cover glass side thereof. After the radiation of the ultraviolet rays, the gel fraction in the pressure-sensitive adhesive layer A′ was measured in the same manner as described.

<Measurement of Separator Peel strength>

The separator (release liner) attached measuring sample, which was any one of the samples yielded in each of the working examples and the comparative examples, was cut into a size having a width of 50 mm and a length of 100 mm. Thereafter, a tensile tester was used to peel the separator (release liner) from the sample at a peeling angle of 180° and a peeling speed of 300 mm/min. At this time, the peel strength (N/50-mm) was measured.

<Method for Evaluating step-absorbing capability>

In each of the working examples and the comparative examples, some of the pressure-sensitive adhesive layers prepared in the production examples were used to produce a pressure-sensitive adhesive layer A shown in Table 1 separately. This layer was used as a measuring sample. This measuring sample was cut into a size having a width of 50 mm and a length of 100 mm, and then a hand roller was used to bond the pressure-sensitive adhesive layer A side of the cut-out sample onto a COP (cyclic polyolefin) film (thickness: 100 μm).

Next, the release liner was peeled from the COP-film-bonded measuring sample. A glass plate having a printed-step was bonded onto the COP film to bring the step arranged surface of this glass plate into contact with the pressure-sensitive adhesive layer A of the COP film under bonding conditions described below. In this way, an evaluating sample was yielded, which had a structure of “COP film/pressure-sensitive adhesive layer A/glass plate having a printed-step”.

### Bonding Conditions:

Surface pressure: 0.3 MPa

Bonding speed: 25 mm/s

Roll rubber hardness: 70°

The used glass plate having a printed-step was a glass plate (manufactured by Matsunami Glass Ind., Ltd.; length: 100 mm, width: 50 mm, and thickness: 0.7 mm) having one surface on which printing was made to have printed regions having a thickness (step height) of 50 μm or 80 μm.

The value (%) of {[“step height”/“thickness of the pressure-sensitive adhesive layer”]×100} thereof was 50% or 80%, this value being a factor representing step-absorbing capability.

Next, the evaluating sample was put into an autoclave, and then subjected to autoclave treatment at a pressure of 5 atom and a temperature of 50° C. for 15 minutes. After the autoclave treatment, the evaluating sample was taken out to observe a bonding state between the pressure-sensitive adhesive layer and the glass plate having a printed-step visually. The step-absorbing capability of the sample was evaluated in accordance with the following evaluating criterion:

⊚: bubbles having a size of 50 μm or more were not left, so that no gap having a height of 50 μm or more was generated between the pressure-sensitive adhesive layer and the glass plate having a printed-step.

◯: bubbles having a size of 100 μm or more were not left, so that no gap having a height of 100 μm or more was generated between the pressure-sensitive adhesive layer and the glass plate having a printed-step.

s: bubbles having a size more than 100 μm were left, so that gaps were generated between the pressure-sensitive adhesive layer and the glass plate having a printed-step.

### <Durability>

The separator (release liner) of the pressure-sensitive adhesive layer A (at the viewer-side) of each of any two of the pressure-sensitive-adhesive-layer-attached polarizing films yielded in each of the above-mentioned examples was peeled, and then bonded onto a cover glass having a thickness of 0.7 mm and made of non-alkali glass (1737, manufactured by Corning Inc.), using a laminator. Next, the resultants were each subjected to autoclave treatment at 50° C. and 0.5 MPa for 15 minutes to cause the pressure-sensitive-adhesive-layer-attached polarizing film to adhere closely onto the cover glass. Next, a vacuum bonding device manufactured by Lantech Inc. was used to vacuum-bond these members onto each other at a pressure of 0.2 MPa and a vacuum degree of 30 Pa. The resultant samples were put into a 80° C., 95° C. heating-oven (heated) and a 60° C./95%-RH thermostat (humidified), respectively. After 500 hours, the respective durabilities of the samples were evaluated by determining whether or not their polarizing film was peeled in accordance with the following criterion:

⊚: no peel was recognized.

◯: such a peel that was unable to be visually recognized was present.

Δ: such a slight peel that was able to be visually recognized was present.

s: a clear peel was recognized.

About the pressure-sensitive adhesive layer A of each of Examples 4 to 14, and Comparative Examples 1 to 3, the measurement was made about the pressure-sensitive adhesive layer A′ thereof, which was a layer improved in crosslinkage degree by radiating the UV rays (3000 mJ/m²) across the cover glass after the layer A was bonded to the cover glass.

### <Edge External Appearance>

◯: after 24 hours elapsed while a temperature of 30° C. was kept after the production (and processing) of the pressure-sensitive adhesive layer A of the pressure-sensitive-adhesive-layer-attached polarizing film as the measuring sample, no pressure-sensitive adhesive was protruded from the edge of the polarizing film.

x: after 24 hours elapsed while a temperature of 30° C. was kept after the production (and processing) of the pressure-sensitive adhesive layer A of the pressure-sensitive-adhesive-layer-attached polarizing film, the pressure-sensitive adhesive was protruded from the edge of the polarizing film.

### <Static Electricity Unevenness Evaluation>

The measuring sample (pressure-sensitive-adhesive-layer-attached polarizing film) was cut into a size of 100 mm×100 mm, and the pressure-sensitive adhesive layer B side thereof was bonded to a liquid crystal panel. This panel was put onto a backlight giving a luminance of 10000 cd. A static electricity generating device ESD (ESD-8012A, manufactured by a company, Sanki) was used to generate static electricity having a voltage of 5 kV to cause a disturbance of the orientation of the liquid crystal. An instantaneous multi-photometric detector (MCPD-3000, manufactured by Otsuka Electronics Co., Ltd.) was used to measure the period (seconds) until a display failure based on this orientation defect recovered, and then the static electricity unevenness of the sample was measured in accordance with the following criterion:

◯: the display failure was lost in a period shorter than 10 seconds.

x: the display failure was lost in a period of 10 seconds or longer.

TABLE 1

| | Pressure-sensitive-adhesive-layer-attached polarizing film structure | | | | | | | | | | | | | |
|---|---|---|---|---|---|---|---|---|---|---|---|---|---|---|
| | | | | | | | | | Distance to | | | | | |
| | Polarizing film | | Pressure-sensitive adhesive layer A | | | | | | inner edge of pressure- | | | | | |
| | | Adhesion- | (a) | | (b) | | (c) | | sensitive adhesive layer A | | | | Pressure-sensitive | |
| | | facilitating | | Thickness | | Thickness | | Thickness | (a) | (b) | (c) | | adhesive layer B | Antistatic |
| | Type | layer | Type | (μm) | Type | (μm) | Type | (μm) | X (μm) | Y (μm) | Z (μm) | UV radiation | Type | layer |
| Example 1 | P2 | Not done | a-1 | 20 | b-1 | 150 | Not done | — | 20 | 120 | — | Not done | B1 | Antistatic |
| | | | | | | | | | | | | | | layer 1 |
| Example 2 | P2 | Not done | a-1 | 20 | b-1 | 110 | c-1 | 20 | 30 | 120 | 30 | Not done | B1 | Antistatic |
| | | | | | | | | | | | | | | layer 1 |
| Example 3 | P2 | Not done | a-1 | 20 | b-1 | 110 | c-1 | 20 | 20 | 100 | 20 | Not done | B1 | Antistatic |
| | | | | | | | | | | | | | | layer 1 |
| Example 4 | P2 | Not done | a-2 | 25 | b-2 | 50 | c-2 | 25 | 30 | 70 | 30 | Done | B1 | Antistatic |
| | | | | | | | | | | | | | | layer 1 |
| Example 5 | P2 | Not done | a-2 | 25 | b-2 | 100 | c-2 | 25 | 30 | 150 | 30 | Done | B1 | Antistatic |
| | | | | | | | | | | | | | | layer 1 |
| Example 6 | P2 | Not done | a-2 | 25 | b-2 | 150 | c-2 | 25 | 30 | 150 | 30 | Done | B1 | Antistatic |
| | | | | | | | | | | | | | | layer 1 |
| Example 7 | P2 | Corona | a-2 | 25 | b-2 | 150 | c-2 | 25 | 30 | 150 | 30 | Done | B1 | Antistatic |
| | | | | | | | | | | | | | | layer 1 |
| Example 8 | P2 | Plasma | a-2 | 25 | b-2 | 150 | c-2 | 25 | 30 | 150 | 30 | Done | B1 | Antistatic |
| | | | | | | | | | | | | | | layer 1 |
| Example 9 | P2 | Excimer | a-2 | 25 | b-2 | 150 | c-2 | 25 | 30 | 150 | 30 | Done | B1 | Antistatic |
| | | | | | | | | | | | | | | layer 1 |
| Example 10 | P2 | HC | a-2 | 25 | b-2 | 150 | c-2 | 25 | 30 | 150 | 30 | Done | B2 | Antistatic |
| | | | | | | | | | | | | | | layer 2 |
| Example 11 | P2 | Not done | a-2 | 25 | b-2 | 150 | c-2 | 25 | 30 | 150 | 30 | Done | B1 | Not |
| | | | | | | | | | | | | | | Done |
| Example 12 | P2 | Not done | a-1 | 25 | b-2 | 150 | Not done | — | 30 | 150 | — | Done | B1 | Antistatic |
| | | | | | | | | | | | | | | layer 1 |
| Example 13 | P2 | Not done | a-2 | 100 | b-2 | 50 | c-2 | 100 | 100 | 150 | 100 | Done | B1 | Antistatic |
| | | | | | | | | | | | | | | layer 1 |
| Example 14 | P2 | Not done | a-2 | 25 | b-2 | 150 | c-2 | 25 | 0 | 0 | — | Done | B1 | Antistatic |
| | | | | | | | | | | | | | | layer 1 |
| Comparative | P2 | Not done | a-1 | 150 | Not done | — | Not done | — | 50 | — | — | Not done | B1 | Antistatic |
| Example 1 | | | | | | | | | | | | | | layer 1 |
| Comparative | P2 | Not done | a-2 | 150 | Not done | — | Not done | — | 30 | | — | Done | B1 | Antistatic |
| Example 2 | | | | | | | | | | | | | | layer 1 |
| Comparative | P2 | Not done | Not done | — | b-2 | 150 | Not done | — | — | 30 | — | Done | B1 | Antistatic |
| Example 3 | | | | | | | | | | | | | | layer 1 |

| | Pressure-sensitive adhesive layer A | | | | | | | | | | | | |
|---|---|---|---|---|---|---|---|---|---|---|---|---|---|
| | After first curing | | | | | | | | | | | | |
| | | | Separator | After second | Pressure-sensitive adhesive layer B | | | Evaluations | | | | | |
| | Storage | | peel | (pressure-sensitive | | | Separator | step- | Durability | | | | |
| | nodulus | Gel | strength | adhesive layer A′) | Storage | | peel strength | absorbing | | | 60° C./95% | Edge external | Static electricity |
| | Mpa | fraction % | N/50 mm | Gel fraction % | nodulus Mpa | Gel fraction % | N/50 mm | capability | 85° C. | 95° C. | RH | appearance | unevenness |
| Example 1 | 0.08 | 60 | 0.2 | — | 0.30 | 80 | 0.1 | ○ | ○ | ○ | ○ | ○ | ○ |
| Example 2 | 0.07 | 60 | 0.2 | — | 0.30 | 80 | 0.1 | ○ | ○ | ○ | ○ | ○ | ○ |
| Example 3 | 0.07 | 60 | 0.2 | — | 0.30 | 80 | 0.1 | ○ | ○ | ○ | ○ | ○ | ○ |
| Example 4 | 0.09 | 65 | 0.3 | 75 | 0.30 | 80 | 0.1 | ⊙ | ⊙ | ○ | ○ | ○ | ○ |
| Example 5 | 0.08 | 60 | 0.3 | 75 | 0.30 | 80 | 0.1 | ⊙ | ⊙ | ○ | ○ | ○ | ○ |
| Example 6 | 0.06 | 50 | 0.3 | 75 | 0.30 | 80 | 0.1 | ⊙ | ⊙ | ○ | ○ | ○ | ○ |
| Example 7 | 0.06 | 50 | 0.3 | 75 | 0.30 | 80 | 0.1 | ⊙ | ⊙ | ⊙ | ○ | ○ | ○ |
| Example 8 | 0.06 | 50 | 0.3 | 75 | 0.30 | 80 | 0.1 | ⊙ | ⊙ | ⊙ | ○ | ○ | ○ |
| Example 9 | 0.06 | 50 | 0.3 | 75 | 0.30 | 80 | 0.1 | ⊙ | ⊙ | ⊙ | ○ | ○ | ○ |
| Example 10 | 0.06 | 50 | 0.3 | 75 | 0.30 | 80 | 0.1 | ⊙ | ⊙ | ⊙ | ○ | ○ | ○ |
| Example 11 | 0.06 | 50 | 0.3 | 75 | 0.30 | 80 | 0.1 | ⊙ | ⊙ | ○ | ○ | ○ | Δ |
| Example 12 | 0.07 | 60 | 0.2 | 75 | 0.30 | 80 | 0.1 | ○ | ○ | ○ | ○ | ○ | ○ |
| Example 13 | 0.05 | 40 | 0.3 | 75 | 0.30 | 80 | 0.1 | ○ | Δ | ○ | ○ | ○ | ○ |
| Example 14 | 0.06 | 60 | 0.3 | 75 | 0.30 | 80 | 0.1 | ○ | ○ | ○ | ○ | x | ○ |
| Comparative | 0.3 | 80 | 0.2 | — | 0.30 | 80 | 0.1 | x | ○ | ○ | ○ | ○ | ○ |
| Example 1 | | | | | | | | | | | | | |
| Comparative | 0.03 | 40 | 0.4 | 55 | 0.30 | 80 | 0.1 | ⊙ | x | x | ○ | x | ○ |
| Example 2 | | | | | | | | | | | | | ○ |
| Comparative | 0.32 | 80 | 0.3 | 85 | 0.30 | 80 | 0.1 | x | x | x | x | ○ | ○ |
| Example 3 | | | | | | | | | | | | | |

### DESCRIPTION OF REFERENCE SIGNS

1 a polarizing film
A pressure-sensitive adhesive layer A (viewer side)
B pressure-sensitive adhesive layer B (opposite to the viewer side)
C member (touch panel or transparent substrate)
D image display device
   2 pressure-sensitive adhesive layer (pressure-sensitive adhesive layer B)
   3 transparent conductive layer (antistatic layer)
   4 glass substrate
   5 liquid crystal layer
   6 driving electrode
   7 antistatic layer functioning also as a sensor layer
   8 driving electrode functioning also as a sensor layer
   9 sensor layer

What is claimed is:

1. A pressure-sensitive-adhesive-layer-attached polarizing film, comprising:
a polarizing film which is provided nearest to a viewer-side of an image display device among at least one polarizing film used in the device,
a pressure-sensitive adhesive layer A arranged at a viewer-side of the polarizing film, and
a pressure-sensitive adhesive layer B arranged at a side of the polarizing film that is opposite to the viewer-side of the polarizing film;
wherein the pressure-sensitive adhesive layer A is a multiple pressure-sensitive adhesive layer having at least a first pressure-sensitive adhesive layer (a) and a second pressure-sensitive adhesive layer (b) in an order of the recited layers from the outermost surface side of the pressure-sensitive adhesive layer A.

2. The pressure-sensitive-adhesive-layer-attached polarizing film according to claim 1, wherein the pressure-sensitive adhesive layer A and the pressure-sensitive adhesive layer B each is obtained from an acrylic pressure-sensitive adhesive comprising, as a base polymer, a (meth)acryl-based polymer containing, as a monomer unit, an alkyl (meth)acrylate;
the (meth)acryl-based polymer of the pressure-sensitive adhesive layer A comprises, as the monomer unit, 2-ethylhexyl acrylate in a most proportion; and
the (meth)acryl-based polymer of the pressure-sensitive adhesive layer B comprises, as the monomer unit, butyl acrylate in a most proportion.

3. The pressure-sensitive-adhesive-layer-attached polarizing film according to claim 1, wherein the first pressure-sensitive adhesive layer (a) in the pressure-sensitive adhesive layer A and the pressure-sensitive adhesive layer B each is obtained from an acrylic pressure-sensitive adhesive comprising, as a base polymer, a (meth)acryl-based polymer containing an alkyl (meth)acrylate as a monomer unit; and
at least one of the (meth) acryl-based polymer of the first pressure-sensitive adhesive layer (a) of the outermost surface in the pressure-sensitive adhesive layer A, and the (meth) acryl-based polymer of the pressure-sensitive adhesive layer B comprises, as a monomer unit, at least one of (meth)acrylic acid and a cyclic nitrogen-containing monomer.

4. The pressure-sensitive-adhesive-layer-attached polarizing film according to claim 1, wherein the thickness of the first pressure-sensitive adhesive layer (a) of the outermost surface is smallest among all layers of the multiple pressure-sensitive adhesive layer, which is the pressure-sensitive adhesive layer A.

5. The pressure-sensitive-adhesive-layer-attached polarizing film according to claim 1, wherein at least one portion of the edge of the multiple pressure-sensitive adhesive layer, which is the pressure-sensitive adhesive layer A, is positioned inwards from an edge side of the plane of the polarizing film;
the distance X between the edge side of the plane of the polarizing film, and the edge of the first pressure-sensitive adhesive layer (a) of the outermost surface, which is positioned inwards from the edge side of the plane of the polarizing film, is larger than the distance Y between the edge side of the plane of the polarizing film, and the edge of the second pressure-sensitive adhesive layer (b), which is positioned inwards from the edge side of the plane of the polarizing film.

6. The pressure-sensitive-adhesive-layer-attached polarizing film according to claim 1, wherein the pressure-sensitive adhesive layer A is a multiple pressure-sensitive adhesive layer having at least the first pressure-sensitive adhesive layer (a), the second pressure-sensitive adhesive layer (b), and a third pressure-sensitive adhesive layer (c) in an order of the recited layers from the outermost surface side of the pressure-sensitive adhesive layer A.

7. The pressure-sensitive-adhesive-layer-attached polarizing film according to claim 1, wherein a separator SA is provided on the pressure-sensitive adhesive layer A, and a separator SB is provided on the pressure-sensitive adhesive layer B; and
the separator SA is higher in peel strength than the separator SB.

8. The pressure-sensitive-adhesive-layer-attached polarizing film according to claim 1, wherein any moiety of the pressure-sensitive-adhesive-layer-attached polarizing film has an antistatic function.

9. The pressure-sensitive-adhesive-layer-attached polarizing film according to claim 1, wherein a surface of the polarizing film on which the pressure-sensitive adhesive layer A is laminated is subjected to an adhesion-facilitating treatment.

10. An image display device, comprising at least one pressure-sensitive-adhesive-layer-attached polarizing films;
wherein the pressure-sensitive-adhesive-layer-attached polarizing film nearest to a viewer-side of an image display device among at least one polarizing film used in the device, is the pressure-sensitive-adhesive-layer-attached polarizing film recited in claim 1; and
the pressure-sensitive adhesive layer A of the pressure-sensitive-adhesive-layer-attached polarizing film is positioned at the viewer-side, and the pressure-sensitive adhesive layer B of the pressure-sensitive-adhesive-layer-attached polarizing film is positioned at a display section side of the device.

11. The image display device according to claim 10, which is applied to an in-cell or on-cell touch-sensor built-in liquid crystal display device.

12. The pressure-sensitive-adhesive-layer-attached polarizing film according to claim 2, wherein the first pressure-sensitive adhesive layer (a) in the pressure-sensitive adhesive layer A and the pressure-sensitive adhesive layer B each is obtained from an acrylic pressure-sensitive adhesive comprising, as a base polymer, a (meth)acryl-based polymer containing an alkyl (meth)acrylate as a monomer unit; and
at least one of the (meth) acryl-based polymer of the first pressure-sensitive adhesive layer (a) of the outermost surface in the pressure-sensitive adhesive layer A, and the (meth) acryl-based polymer of the pressure-sensitive adhesive layer B comprises, as a monomer unit, at least one of (meth)acrylic acid and a cyclic nitrogen-containing monomer.

13. The pressure-sensitive-adhesive-layer-attached polarizing film according to claim 2, wherein the thickness of the first pressure-sensitive adhesive layer (a) of the outermost surface is smallest among all layers of the multiple pressure-sensitive adhesive layer, which is the pressure-sensitive adhesive layer A.

14. The pressure-sensitive-adhesive-layer-attached polarizing film according to claim 3, wherein the thickness of the first pressure-sensitive adhesive layer (a) of the outermost surface is smallest among all layers of the multiple pressure-sensitive adhesive layer, which is the pressure-sensitive adhesive layer A.

15. The pressure-sensitive-adhesive-layer-attached polarizing film according to claim 2, wherein at least one portion of the edge of the multiple pressure-sensitive adhesive layer, which is the pressure-sensitive adhesive layer A, is positioned inwards from an edge side of the plane of the polarizing film;
the distance X between the edge side of the plane of the polarizing film, and the edge of the first pressure-sensitive adhesive layer (a) of the outermost surface, which is positioned inwards from the edge side of the plane of the polarizing film, is larger than the distance Y between the edge side of the plane of the polarizing film, and the edge of the second pressure-sensitive adhesive layer (b), which is positioned inwards from the edge side of the plane of the polarizing film.

16. The pressure-sensitive-adhesive-layer-attached polarizing film according to claim 3, wherein at least one portion of the edge of the multiple pressure-sensitive adhesive layer, which is the pressure-sensitive adhesive layer A, is positioned inwards from an edge side of the plane of the polarizing film;
the distance X between the edge side of the plane of the polarizing film, and the edge of the first pressure-sensitive adhesive layer (a) of the outermost surface, which is positioned inwards from the edge side of the plane of the polarizing film, is larger than the distance Y between the edge side of the plane of the polarizing film, and the edge of the second pressure-sensitive adhesive layer (b), which is positioned inwards from the edge side of the plane of the polarizing film.

17. The pressure-sensitive-adhesive-layer-attached polarizing film according to claim 4, wherein at least one portion of the edge of the multiple pressure-sensitive adhesive layer, which is the pressure-sensitive adhesive layer A, is positioned inwards from an edge side of the plane of the polarizing film;
the distance X between the edge side of the plane of the polarizing film, and the edge of the first pressure-sensitive adhesive layer (a) of the outermost surface, which is positioned inwards from the edge side of the plane of the polarizing film, is larger than the distance Y between the edge side of the plane of the polarizing film, and the edge of the second pressure-sensitive adhesive layer (b), which is positioned inwards from the edge side of the plane of the polarizing film.

18. The pressure-sensitive-adhesive-layer-attached polarizing film according to claim 2, wherein the pressure-sensitive adhesive layer A is a multiple pressure-sensitive adhesive layer having at least the first pressure-sensitive adhesive layer (a), the second pressure-sensitive adhesive layer (b), and a third pressure-sensitive adhesive layer (c) in an order of the recited layers from the outermost surface side of the pressure-sensitive adhesive layer A.

19. The pressure-sensitive-adhesive-layer-attached polarizing film according to claim 3, wherein the pressure-sensitive adhesive layer A is a multiple pressure-sensitive adhesive layer having at least the first pressure-sensitive adhesive layer (a), the second pressure-sensitive adhesive layer (b), and a third pressure-sensitive adhesive layer (c) in an order of the recited layers from the outermost surface side of the pressure-sensitive adhesive layer A.

20. The pressure-sensitive-adhesive-layer-attached polarizing film according to claim 4, wherein the pressure-sensitive adhesive layer A is a multiple pressure-sensitive adhesive layer having at least the first pressure-sensitive adhesive layer (a), the second pressure-sensitive adhesive layer (b), and a third pressure-sensitive adhesive layer (c) in an order of the recited layers from the outermost surface side of the pressure-sensitive adhesive layer A.
